(19) United States
(12) Patent Application Publication
(10) Pub. No.: US 2008/0216177 A1
(43) Pub. Date: Sep. 4, 2008

(54) Contents Distribution System

(76) Inventors: Junichi Yokosato, Tokyo (JP); Yoshiaki Kato, Tokyo (JP)

Correspondence Address: BIRCH STEWART KOLASCH & BIRCH, PO BOX 747, FALLS CHURCH, VA, 22040-0747, US

(21) Appl. No.: 11/795,577

(22) PCT Filed: Feb. 28, 2005
(86) PCT No.: PCT/JP2005/003319

§ 371 Date: Jul. 19, 2007

(51) Int. Cl. G06F 21/00

(52) U.S. Cl. 726/26

(57) ABSTRACT

When the DRM mode indicated by a client terminal 1 differs from DRM (Digital Rights Management) modes available to a license server 2 and a distribution server 4, the license server 2 requests a DRM mode converting server 6 to convert the DRM mode of the multimedia contents. When the DRM mode converting server 6 receives the conversion request of the DRM mode, it converts the DRM mode of the multimedia contents distributed from the distribution server 4 to the DRM mode available to the client terminal 1, and transfers the multimedia contents passing through the conversion to the client terminal 1.

### TECHNICAL FIELD

The present invention relates to a contents distribution system for distributing multimedia contents to client terminals through a network.

### BACKGROUND ART

A conventional contents distribution system includes a license server for managing license information, a distribution server for distributing multimedia contents, and a client terminal for receiving and restoring the multimedia contents, which are connected to a network.

When the distribution server distributes multimedia contents to a client terminal via the network, even if the distribution server and the client terminal employ the same distribution protocol, if they have different digital rights management (abbreviated to DRM from now on) modes of the multimedia contents, the distribution server cannot distribute the multimedia contents to the client terminal.

The contents distribution system disclosed in the following patent document 1 has a license-issuing server which has a plurality of DRM modes and is connected to a network.

The license-issuing server of the contents distribution system collects information about the DRM modes available to the client terminal, and selects the DRM mode that agrees with the DRM mode available to the client terminal from the plurality of DRM modes installed in advance.

The distribution server of the contents distribution system distributes the multimedia contents to the client terminal using the DRM mode selected by the license-issuing server.

Accordingly, the contents distribution system can increase the probability that the distribution server can distribute the multimedia contents to the client terminal if the license-issuing server installs many DRM modes.

Patent document 1: Japanese patent application laid-open No. 2004-240959 (Page 2 and FIG. 2).

The conventional contents distribution system is configured as described above. Thus, the distribution server can distribute the multimedia contents to the client terminal if the license-issuing server include a DRM mode available to the client terminal in the plurality of DRM modes installed therein in advance. However, if it does not include the DRM mode available to the client terminal, the license-issuing server offers a problem in that the distribution server cannot distribute the multimedia contents to the client terminal unless the license-issuing server is repaired.

The present invention is implemented to solve the foregoing problem. Therefore it is an object of the present invention to provide a contents distribution system capable of distributing the multimedia contents to the client terminal even if the DRM mode available to the client terminal is not included in the plurality of DRM modes.

### DISCLOSURE OF THE INVENTION

The contents distribution system in accordance with the present invention is configured in such a manner that when a DRM mode indicated by a client terminal differs from DRM modes available to a contents distribution apparatus, the contents distribution apparatus requests a DRM mode converting apparatus to convert the DRM mode in the multimedia contents; and when the DRM mode converting apparatus receives the conversion request of the DRM mode from the contents distribution apparatus, it converts the DRM mode of the multimedia contents distributed from the contents distribution apparatus to the DRM mode available to the client terminal, and transfers the multimedia contents passing through the conversion to the client terminal.

Thus, it offers an advantage of being able to distribute the multimedia contents to the client terminal even when none of the plurality of DRM modes installed in advance include the DRM mode available to the client terminal.

### BRIEF DESCRIPTION OF THE DRAWINGS

FIG. 1 is a block diagram showing a configuration of a contents distribution system of an embodiment 1 in accordance with the present invention;

FIG. 2 is a block diagram showing a configuration of a client terminal 1 of the contents distribution system of the embodiment 1 in accordance with the present invention;

FIG. 3 is a block diagram showing a configuration of a license server 2 and distribution server 4 of the contents distribution system of the embodiment 1 in accordance with the present invention;

FIG. 4 is a block diagram showing a configuration of a DRM mode converting server 6 of the contents distribution system of the embodiment 1 in accordance with the present invention;

FIG. 5 is a sequence chart illustrating the processing of the contents distribution system of the embodiment 1 in accordance with the present invention;

FIG. 6 is a diagram illustrating license data and the like managed by a license data management DB 3;

FIG. 7 is a sequence chart illustrating command transfer according to RTSP;

FIG. 8 is a block diagram showing a configuration of the license server 2 and distribution server 4 of the contents distribution system of an embodiment 2 in accordance with the present invention;

FIG. 9 is a block diagram showing a configuration of the DRM mode converting server 6 of the contents distribution system of an embodiment 3 in accordance with the present invention;

FIG. 10 is a sequence chart illustrating the process of conversion from a multicast scheme to a unicast scheme;

FIG. 11 is a block diagram showing a configuration of the license server 2 and distribution server 4 of the contents distribution system of an embodiment 4 in accordance with the present invention;

FIG. 12 is a block diagram showing a configuration of the DRM mode converting server 6 of the contents distribution system of the embodiment 4 in accordance with the present invention;

FIG. 13 is a block diagram showing a configuration of the contents distribution system of an embodiment 5 in accordance with the present invention;

FIG. 14 is a block diagram showing a configuration of a license server 71 and distribution server 72 of the contents distribution system of the embodiment 5 in accordance with the present invention;

FIG. 15 is a sequence chart illustrating the processing of the contents distribution system of the embodiment 5 in accordance with the present invention;

FIG. 16 is a block diagram showing a configuration of the license server 71 and distribution server 72 of the contents distribution system of an embodiment 6 in accordance with the present invention;

FIG. 17 is a block diagram showing a configuration of the license server 71 and distribution server 72 of the contents distribution system of an embodiment 7 in accordance with the present invention;

FIG. 18 is a block diagram showing a major portion of the contents distribution system of the embodiment 7 in accordance with the present invention;

FIG. 19 is a block diagram showing a configuration of the contents distribution system of an embodiment 8 in accordance with the present invention;

FIG. 20 is a block diagram showing a configuration of the client terminal 1 of the contents distribution system of the embodiment 8 in accordance with the present invention;

FIG. 21 is a block diagram showing a configuration of the license server 2 and distribution server 4 of the contents distribution system of the embodiment 8 in accordance with the present invention;

FIG. 22 is a block diagram showing a configuration of the DRM mode converting server 6 of the contents distribution system of the embodiment 8 in accordance with the present invention;

FIG. 23 is a sequence chart illustrating the processing of the contents distribution system of the embodiment 8 in accordance with the present invention;

FIG. 24 is a sequence chart illustrating the processing of the contents distribution system of the embodiment 8 in accordance with the present invention;

FIG. 25 is a block diagram showing a configuration of the contents distribution system of an embodiment 9 in accordance with the present invention; and

FIG. 26 is a block diagram showing a configuration of the license server 71 and distribution server 72 of the contents distribution system of the embodiment 9 in accordance with the present invention.

### BEST MODE FOR CARRYING OUT THE INVENTION

The best mode for carrying out the invention will now be described with reference to the accompanying drawings to explain the present invention in more detail.

### Embodiment 1

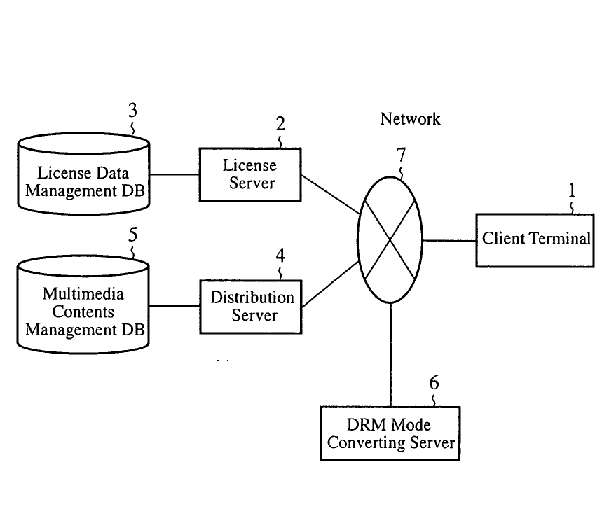

FIG. 1 is a block diagram showing a configuration of the contents distribution system of an embodiment 1 in accordance with the present invention. A client terminal 1, which is a terminal such as a personal computer employed by a user, notifies a license server 2 of an available DRM (Digital Rights Management) mode via a network 7. In addition, when multimedia contents are distributed from the distribution server 4 via the network 7, the client terminal 1 restores the multimedia contents.

Receiving access from the client terminal 1, the license server 2 authenticates the client terminal 1. In addition, it requests a DRM mode converting server 6 to convert the DRM mode of the multimedia contents when the DRM mode indicated by the client terminal 1 differs from its available DRM mode (which is the DRM mode available to the license server 2 and distribution server 4, and the DRM mode available to the license server 2 is the same as that available to the distribution server 4).

A license data management DB 3 is a database that manages user license data including the user ID, password and client certificate of an authorized user of the distribution of the multimedia contents. It includes the data used for the user authentication in a license management application on the server side.

Receiving a distribution request of the multimedia contents from the client terminal 1 authorized by the license server 2, the distribution server 4 retrieves the multimedia contents from a multimedia contents management DB 5. If the license server 2 requests the DRM mode converting server 6 to convert the DRM mode, the distribution server 4 delivers the multimedia contents to the DRM mode converting server 6. Unless the license server 2 requests the DRM mode converting server 6 to convert the DRM mode, the distribution server 4 distributes the multimedia contents to the client terminal 1.

The multimedia contents management DB 5 is a database that manages a plurality of multimedia contents.

Here, the license server 2 and distribution server 4 constitute a contents distribution apparatus. They can be placed either in the same provider or in different providers.

Receiving a conversion request of the DRM mode from the license server 2, the DRM mode converting server 6 converts the DRM mode of the multimedia contents distributed from the distribution server 4 into the DRM modes available to the client terminal 1, and transfers the converted multimedia contents to the client terminal 1.

Here, the DRM mode converting server 6 constitutes a DRM mode converting apparatus.

It is assumed in the present embodiment 1 that the user can browse the multimedia contents by purchasing a browsing right of the multimedia contents the distribution server 4 offers, and by carrying out streaming by the time when the term of validity expires. Alternatively, it is assumed that the user can browse the multimedia contents a designated number of times.

In addition, as for protocols other than the DRM mode, the present embodiment 1 assumes that the client terminal 1 is connectable to the license server 2 and distribution server 4 by using the same standard protocol.

Incidentally, it is assumed in the present embodiment 1 that the stream distribution protocol of the media employs the RTP (Real-time Transport Protocol), and the stream control protocol such as a start, pause and stop of reproduction employs the RTSP (Real Time Streaming Protocol) for convenience of explanation.

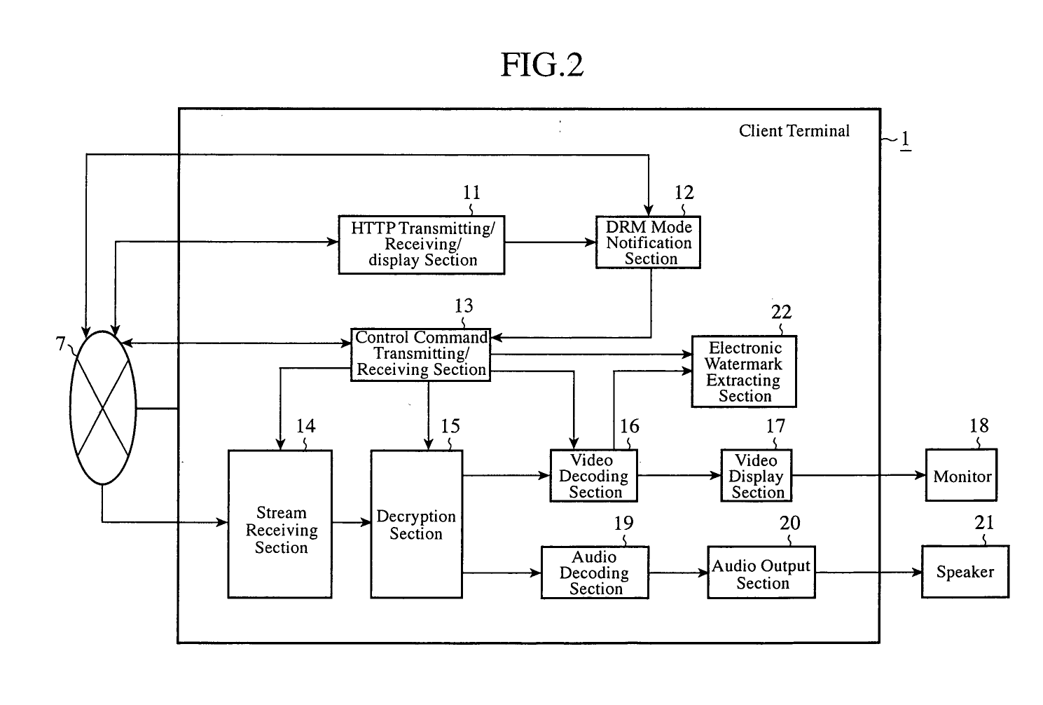

FIG. 2 is a block diagram showing a configuration of the client terminal 1 of the contents distribution system of the embodiment 1 in accordance with the present invention. In FIG. 2, an HTTP transmitting/receiving/display section 11 has a network interface with the network 7, and carries out information input from and output to the network 7. In addition, it has an input interface such as a keyboard and mouse, and an output interface such as a monitor for displaying information.

A DRM mode notification section 12 has a network interface with the network 7, and has a function to transmit the DRM modes available to the client terminal 1 to the license server 2.

A control command transmitting/receiving section 13 has a network interface with the network 7, and has a function to control a stream receiving section 14, decryption section 15 and video decoding section 16 by exchanging control commands with the distribution server 4, DRM mode converting server 6 and the like.

The stream receiving section 14 has a network interface with the network 7, and carries out receiving processing of RTP packets (which include multimedia contents composed of video and audio multimedia data and the like) distributed from the distribution server 4 or DRM mode converting server 6 under the control of the control command transmitting/receiving section 13.

The decryption section 15 decodes the encryption of the multimedia data in the RTP packet received from the stream receiving section 14, and supplies video multimedia data to the video decoding section 16 and audio multimedia data to an audio decoding section 19 under the control of the control command transmitting/receiving section 13.

The video decoding section 16 decodes the encoded video multimedia data supplied from the decryption section 15 under the control of the control command transmitting/receiving section 13.

The video display section 17 displays an image on a monitor 18 in response to the multimedia data decoded by the video decoding section 16.

The audio decoding section 19 decodes the encoded audio multimedia data output from the decryption section 15.

An audio output section 20 outputs the audio from a speaker 21 in response to the multimedia data decoded by the audio decoding section 19 at RTP time stamp timing.

When electronic watermark information is impressed in the multimedia data decoded by the video decoding section 16, an electronic watermark extracting section 22 extracts the electronic watermark information from the multimedia data.

The present embodiment 1 assumes, for example, that the components of the client terminal 1, that is, the HTTP transmitting/receiving/display section 11, DRM mode notification section 12, control command transmitting/receiving section 13, stream receiving section 14, decryption section 15, video decoding section 16, video display section 17, audio decoding section 19, audio output section 20 and electronic watermark extracting section 22, are composed of hardware such as a semiconductor integrated circuit mounting a CPU. However, when the client terminal 1 is composed of a computer, it is also possible for the computer to store programs describing the processing contents of the components in a memory, and for the CPU of the computer to execute the programs.

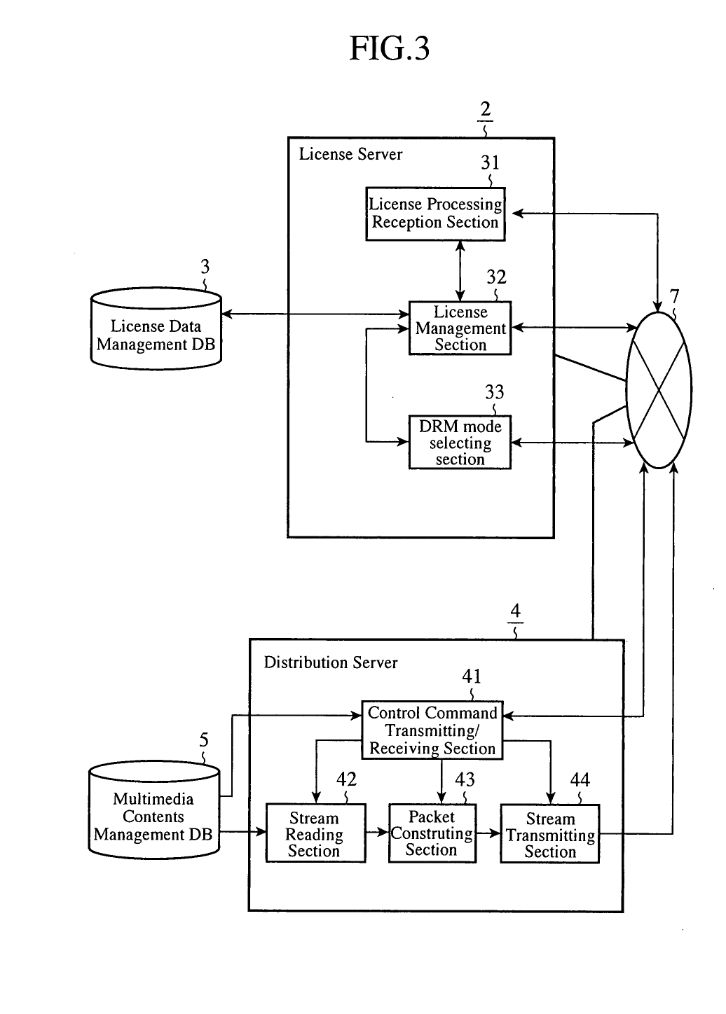

FIG. 3 is a block diagram showing a configuration of the license server 2 and distribution server 4 of the contents distribution system of the embodiment 1 in accordance with the present invention.

In FIG. 3, a license processing reception section 31 of the license server 2 has a network interface with the network 7, and accepts carrying out the authentication of the client terminal 1 when it receives access from the client terminal 1.

A license management section 32 of the license server 2 performs the authentication of the client terminal 1 when the license processing reception section 31 accepts carrying out the authentication processing.

A DRM mode selecting section 33 of the license server 2 has a network interface with the network 7, and when it receives the notification of the available DRM mode from the client terminal 1, it compares the DRM modes available to the client terminal 1 with its own available DRM mode, and selects the DRM mode actually used. In addition, when the DRM modes available to the client terminal 1 differs from its own available DRM mode, the DRM mode selecting section 33 carries out processing such as requesting the DRM mode converting server 6 to convert the DRM mode of the multimedia contents.

The present embodiment 1 assumes that the components of the license server 2, that is, the license processing reception section 31, license management section 32 and DRM mode selecting section 33, are composed of hardware such as a semiconductor integrated circuit mounting a CPU. However, when the license server 2 is composed of a computer, it is also possible for the computer to store programs describing the processing contents of the components in a memory, and for the CPU of the computer to execute the programs.

A control command transmitting/receiving section 41 of the distribution server 4 has a network interface with the network 7, and controls a stream reading section 42, packet constructing section 43 and stream transmitting section 44 by exchanging control commands with the client terminal 1 and the like.

The stream reading section 42 of the distribution server 4 reads multimedia data constituting the multimedia contents from the multimedia contents management DB 5 under the control of the control command transmitting/receiving section 41, and outputs the multimedia data to the packet constructing section 43.

The packet constructing section 43 of the distribution server 4 generates an RTP packet including the encrypted multimedia data output from the stream reading section 42 under the control of the control command transmitting/receiving section 41.

The stream transmitting section 44 of the distribution server 4 has a network interface with the network 7, and distributes the RTP packet generated by the packet constructing section 43 to the DRM mode converting server 6 or client terminal 1 under the control of the control command transmitting/receiving section 41.

The present embodiment 1 assumes that the components of the distribution server 4, that is, the control command transmitting/receiving section 41, stream reading section 42, packet constructing section 43 and stream transmitting section 44, are composed of hardware such as a semiconductor integrated circuit mounting a CPU. However, when the distribution server 4 is composed of a computer, it is also possible for the computer to store programs describing the processing contents of the components in a memory, and for the CPU of the computer to execute the programs.

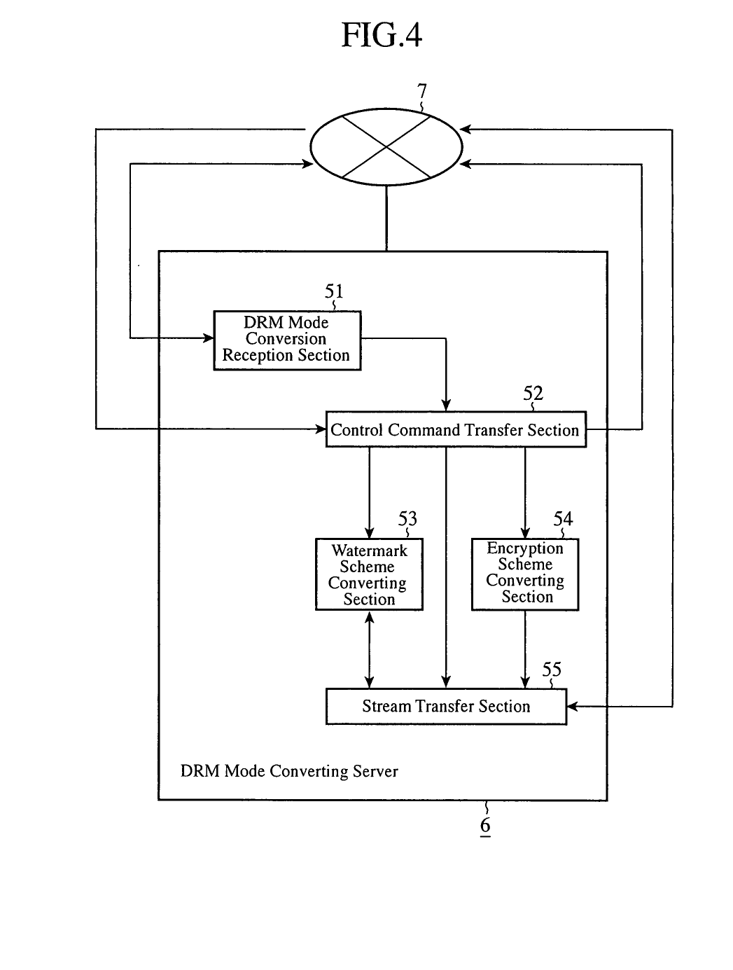

FIG. 4 is a block diagram showing a configuration of the DRM mode converting server 6 of the contents distribution system of the embodiment 1 in accordance with the present invention. In FIG. 4, a DRM mode conversion reception section 51 has a network interface with the network 7, and accepts a conversion request of the DRM mode when receiving it from the license server 2.

A control command transfer section 52 has a network interface with the network 7, and has a function to relay the transmission and reception of control commands between the client terminal 1 and the distribution server 4.

When the DRM mode conversion reception section 51 accepts the conversion request of the DRM mode, a watermark scheme converting section 53 extracts electronic watermark information from the multimedia data contained in the RTP packet which is distributed from the distribution server 4 (and received by a stream transfer section 55), and impresses the electronic watermark information into the multimedia data again in an impressing scheme of the electronic watermark available to the client terminal 1 under the control of the DRM mode conversion reception section 51.

When the DRM mode conversion reception section 51 accepts the conversion request of the DRM mode, an encryption scheme converting section 54 decrypts the encryption of the multimedia data contained in the RTP packet which is distributed from the distribution server 4 (and received by the stream transfer section 55), and encrypts the multimedia data again in the encryption scheme available to the client terminal 1 under the control of the DRM mode conversion reception section 51.

The stream transfer section 55 has a network interface with the network 7, and when it receives the RTP packet distributed from the distribution server 4, it supplies the RTP packet to the watermark scheme converting section 53 and encryption scheme converting section 54, and transfers the RTP packet including the multimedia data output from the watermark scheme converting section 53 and encryption scheme converting section 54 to the client terminal 1.

The present embodiment 1 assumes that the components of the DRM mode converting server 6, that is, the DRM mode conversion reception section 51, control command transfer section 52, watermark scheme converting section 53, encryption scheme converting section 54 and stream transfer section 55, are composed of hardware such as a semiconductor integrated circuit mounting a CPU. However, when the DRM mode converting server 6 is composed of a computer, it is also possible for the computer to store programs describing the processing contents of the components in a memory, and for the CPU of the computer to execute the programs.

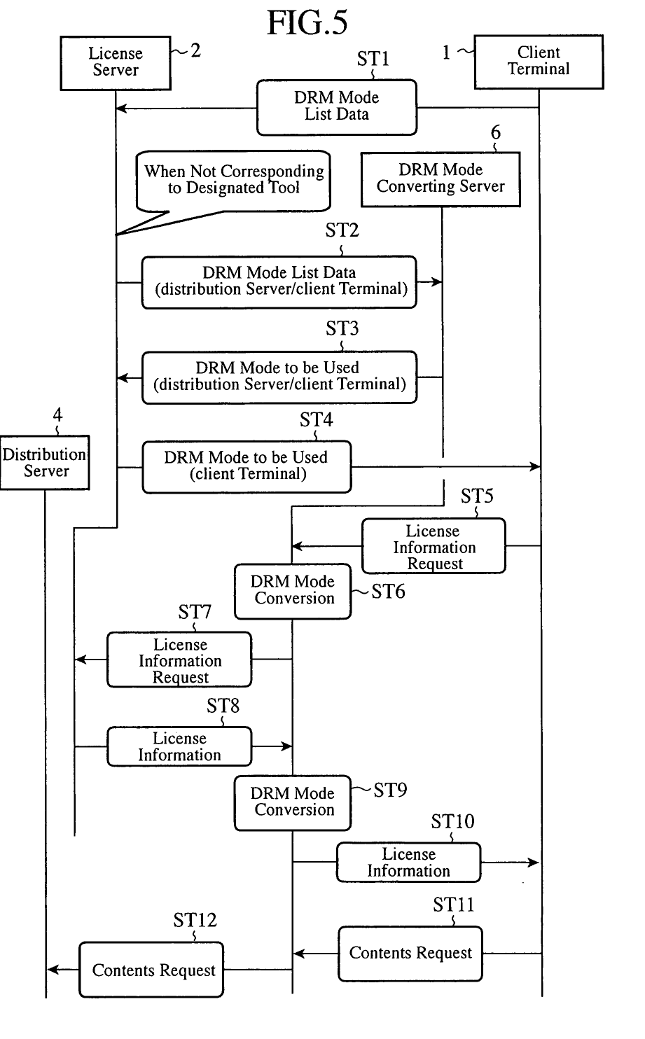

FIG. 5 is a sequence chart illustrating the processing of the contents distribution system of the embodiment 1 in accordance with the present invention.

Next, the operation will be described.

When the user wishes video display or audio output of the multimedia contents, the user operates the HTTP transmitting/receiving/display section 11 of the client terminal 1 to access the license processing reception section 31 of the license server 2.

Receiving the access from the client terminal 1, the license processing reception section 31 of the license server 2 transmits to the client terminal 1 the window data of a login window for accepting carrying out the authentication processing.

When the HTTP transmitting/receiving/display section 11 of the client terminal 1 receives the window data of the login window transmitted from the license server 2, it displays the login window in accordance with the window data.

The login window, which has spaces to input the user ID and password, displays a message for prompting the user to input the user ID and password.

When the user inputs the user ID and password on the login window by operating the HTTP transmitting/receiving/display section 11 of the client terminal 1, it transmits the user ID and password to the license server 2.

It is assumed here that the user ID and password the user inputs are registered in the license data management DB 3 of the license server 2 in advance.

In addition, the license processing reception section 31 of the license server 2 records the secret key of the public key cryptosystem and the server certificate of the license server 2 in advance, and the SSL (Secure Socket Layer) is used for the transmission and reception of the user ID and password.

Receiving the user ID and password transmitted from the client terminal 1, the license processing reception section 31 of the license server 2 supplies the user ID and password to the license management section 32.

Receiving the user ID and password from the license processing reception section 31, the license management section 32 of the license server 2 makes a decision as to whether a pair of the user ID and password corresponding to the pair of the user ID and password is registered in the license data management DB 3 to confirm whether the access is from the authorized user of the distribution of the multimedia contents.

When the corresponding pair of the user ID and password is recorded in the license data management DB 3, the license management section 32 of the license server 2 authorizes the success in the user authentication, and generates a uniquely decided session ID.

Unless the corresponding pair of the user ID and password is recorded in the license data management DB 3, the license management section 32 recognizes the failure in the user authentication, and transmits to the client terminal 1 a message indicating that the license processing reception section 31 cannot distribute the multimedia contents. As described above, it is assumed in the present embodiment 1 that the corresponding pair of the user ID and password is recorded in the license data management DB 3.

Incidentally, when the user authentication processing must also be converted because of the DRM modes employed at the server side and client terminal 1 side, the user authentication processing can also be converted in the same manner as the DRM mode conversion which will be described later.

After the license management section 32 of the license server 2 authorizes the success in the user authentication and generates the uniquely decided session ID, it supplies the session ID to the DRM mode selecting section 33.

The session ID is expressed using a query character string in the URL in the case where a standard protocol such as HTTP or RTSP is employed.

From this time on, the communication between the client terminal 1 and the license server 2 and distribution server 4 are conducted utilizing the session ID so that the individual communications can be handled collectively as a single session.

In addition, the license management section 32 of the license server 2 searches for the multimedia contents available to the user from the license data management DB 3, and supplies the license processing reception section 31 with the list data of the multimedia contents (the list data stores the IDs of the contents the user can browse, and the playing restriction on the contents).

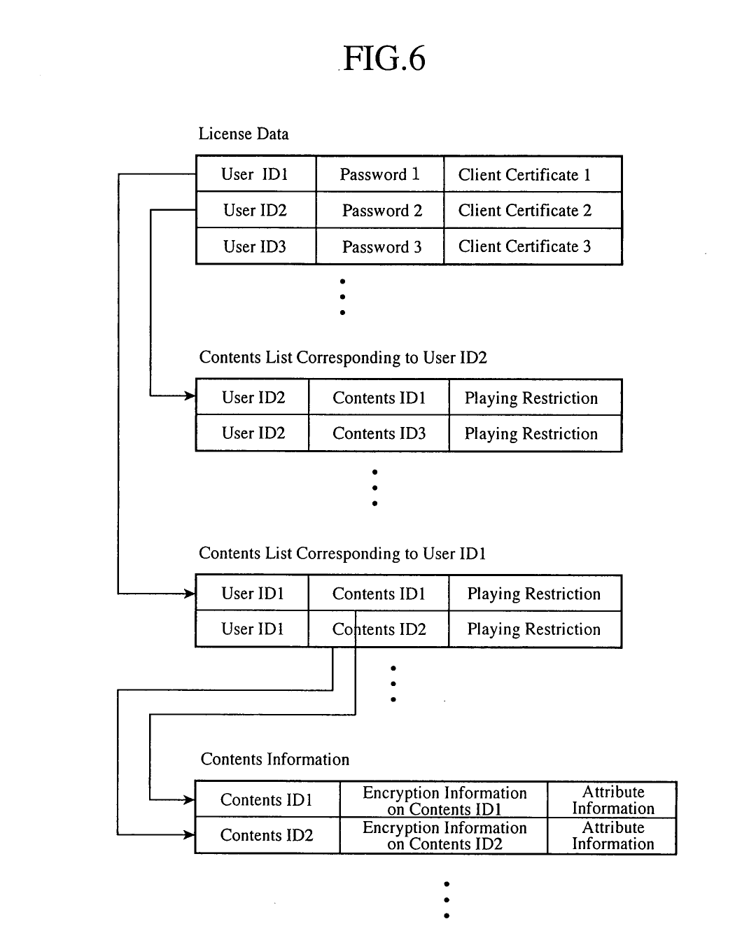

FIG. 6 is a diagram illustrating the license data and the like managed by the license data management DB 3. In the example of FIG. 6, the license data are managed which are composed of sets of the user ID, password and client certificate.

In addition, in the example of FIG. 6, the list data of the multimedia contents are managed which are composed of sets of the user ID, contents ID and playing restriction.

Furthermore, in the example of FIG. 6, the contents information items are managed which are composed of sets of the contents ID, and the encryption information and attribute information about the contents.

The license data management DB 3 illustrated in FIG. 6 is the license data used by the DRM mode employed by the server side. To ensure safety, it is also possible to encrypt the license data management DB 3 itself.

The playing restriction contained in the list data stores the term of validity of the contents browsing, the number of possible times of the browsing and the like. When the number of possible times of the browsing is restricted, it is reduced by one every time the user browses the contents.

In addition, the encryption information of the contents contained in the contents information includes the encryption scheme, key and the like, and the attribute information includes the title, author, reproduction time and production date and the like of the contents.

Receiving the list data of the multimedia contents from the license management section 32, the license processing reception section 31 of the license server 2 converts the list data to the HTML form that can be browsed by the HTTP transmitting/receiving/display section 11 of the client terminal 1, and transmits the list data passing through the form conversion to the client terminal 1.

When the HTTP transmitting/receiving/display section 11 of the client terminal 1 receives the list data of the multimedia contents transmitted from the license server 2, it displays the list of the multimedia contents available to the user in accordance with the list data.

If the available multimedia contents include desired multimedia contents, the user selects the desired multimedia contents by operating the HTTP transmitting/receiving/display section 11 of the client terminal 1.

It is also possible for the user to newly purchase the available multimedia contents. To newly purchase the multimedia contents, the HTTP transmitting/receiving/display section 11 of the client terminal 1 transmits a purchasing request of the multimedia contents to the license server 2.

When the license processing reception section 31 receives the purchasing request of the multimedia contents from the client terminal 1, the license management section 32 of the license server 2 adds the ID of the new multimedia contents to the list data with reference to the license data management DB 3, and the license processing reception section 31 transmits the list data including the ID of the new multimedia contents to the client terminal 1.

When the DRM modes differ in the purchasing of the available multimedia contents as well, it is also possible to carry out the converting processing in the same manner as the DRM mode conversion, which will be described later.

When the HTTP transmitting/receiving/display section 11 of the client terminal 1 receives the list data of the multimedia contents transmitted from the license server 2, it displays the list of the multimedia contents available to the user in accordance with the list data.

Operating the HTTP transmitting/receiving/display section 11 of the client terminal 1, the user selects any desired multimedia contents from the available multimedia contents.

To purchase the new multi media contents, charging processing is carried out. However, since the charging processing has no direct bearing on the contents of the present embodiment 1, the description thereof is omitted here.

When the user selects desired multimedia contents, the DRM mode notification section 12 of the client terminal 1 transmits to the license server 2 the list data of the DRM modes available to the client terminal 1 (such as DRM scheme 1 and DRM scheme 2) (step ST1 of FIG. 5). It is assumed here that the DRM modes available to the client terminal 1 are recorded in advance in the DRM mode notification section 12.

As for an encryption scheme used for the DRM mode, it is decided through the communication between the license server 2 or DRM mode converting server 6 and the client terminal 1 in the protocol of each DRM mode.

Receiving the list data of the available DRM modes transmitted from the client terminal 1, the DRM mode selecting section 33 of the license server 2, referring to the list data, compares the DRM modes available to the client terminal 1 with the DRM mode available to itself (the DRM modes available to the license server 2 and the distribution server 4 are the same, and the available DRM modes are recorded in the DRM mode selecting section 33 in advance), and makes a decision as to whether the DRM modes available to the client terminal 1 can be employed.

When the DRM modes available to the client terminal 1 are included in the DRM modes available to itself, the DRM mode selecting section 33 makes a decision that the DRM modes available to the client terminal 1 can be employed, and selects the DRM mode to be actually used from the DRM modes available to the client terminal 1.

When the DRM mode selecting section 33 selects the DRM mode to be actually used, it sends the DRM mode back to the client terminal 1. Subsequently, using the DRM mode decided between the client terminal 1 and the license server 2, the contents distribution is started.

When none of the DRM modes available to the client terminal 1 are included in the DRM modes available to itself, the DRM mode selecting section 33 of the license server 2 decides that the DRM modes available to the client terminal 1 cannot be used, and transmits the conversion request of the DRM mode of the multimedia contents to the DRM mode converting server 6.

Here, the DRM mode converting server 6 to which the conversion request of the DRM mode is transmitted can be a predetermined server, or can be decided from a result of conducting the search using as the key the DRM mode to which the client terminal 1 and the license server 2 correspond.

In this case, the DRM mode selecting section 33 transmits to the DRM mode converting server 6 the list data of the DRM modes available to the client terminal 1, and the list data of the DRM modes available to the license server 2 and distribution server 4 (step ST2).

In addition, the DRM mode selecting section 33 continuously transmits, following the DRM modes available to the license server 2 and distribution server 4, the list data of the DRM modes available to the client terminal 1, the address of the client terminal 1, and the list data consisting of the session IDs to the DRM mode converting server 6.

Receiving the conversion request of the DRM mode transmitted from the license server 2, and receiving the list data of the DRM modes available to the license server 2 and distribution server 4 and the list data of the DRM modes available to the client terminal 1 (including the address and session ID of the client terminal 1), the DRM mode conversion reception section 51 of the DRM mode converting server 6, referring to the list data of the DRM modes available to the license server 2 and distribution server 4 decides the DRM mode the license server 2 and distribution server 4 actually employ, and transmits the DRM mode to the license server 2 (step ST3).

In addition, the DRM mode conversion reception section 51, referring to the list data of the DRM modes available to the client terminal 1, decides the DRM mode the client terminal 1 actually employs, and transmits the DRM mode to the license server 2 (step ST3).

The multimedia data of the multimedia contents are encrypted in advance, and include the license information as the electronic watermark information.

Receiving the DRM mode the license server 2 and distribution server 4 actually employ from the DRM mode converting server 6, the DRM mode selecting section 33 of the license server 2 transmits the DRM mode the distribution server 4 actually employs and the session ID to the distribution server 4.

In addition, the DRM mode selecting section 33 transmits to the client terminal 1 the DRM mode the client terminal 1 actually employs, the information necessary for the communication with the DRM mode converting server 6 (address and port number, session number and the like), and the contents ID or contents URL of the contents to be accessed (step ST4).

It is assumed here that the URL of the multimedia contents includes the session ID expressed by a query character string and the like.

Thus, between the license server 2 and the DRM mode converting server 6, between the distribution server 4 and the DRM mode converting server 6, and between the DRM mode converting server 6 and the client terminal 1, the transmission and reception have been completed of the information for deciding the license information management mode used for distributing the multimedia contents. These communications can be carried out safely by using the SSL.

Once the DRM mode has been decided which is used between the license server 2 and the DRM mode converting server 6, and between the DRM mode converting server 6 and the client terminal 1, communications for the DRM mode are conducted between them.

For example, assume that between the license server 2 and the DRM mode converting server 6, the DRM mode Ver.2 employed by OMA (Open Mobile Alliance) is used.

In the DRM mode Ver.2 of OMA, when the client terminal 1 requests the DRM mode converting server 6 to provide license information (Right Object in the OMA DRM), the DRM mode converting server 6 sends the license information necessary for restoring the contents back to the client terminal 1.

The request for the license information transmitted from the client side includes the client certificate and contents ID and the like. The response of the license information sent from the server side back to the client side includes the license information. The license information includes the encrypted contents decryption key, a key for decoding the contents decryption key (encrypted by client's public key), reproduction conditions (the number of times of the reproduction, time limit of the reproduction and the like).

Furthermore, it is assumed between the DRM mode converting server 6 and the client terminal 1 that such a system is used in which when the client terminal 1 transmits the client certificate to the DRM mode converting server 6, the DRM mode converting server 6 encrypts the encryption key of the contents with the public key of the client terminal 1, and transmits it together with the reproduction conditions.

The DRM mode notification section 12 of the client terminal 1 transmits its client certificate and the contents ID it requests to the designated DRM mode converting server 6, thereby requesting to provide the information such as the contents decryption key necessary for reproducing the contents (step ST5).

The DRM mode conversion reception section 51 of the DRM mode converting server 6 generates a request for the license information of the OMA DRM mode from the information such as the contents ID transmitted from the client terminal 1 (step ST6), and transmits the request for the license information to the license server 2 (step ST7).

Here, as the client certificate contained in the request for the license information to be transmitted to the license server 2, the client certificate of the DRM mode converting server 6 is employed rather than the client certificate of the client terminal 1.

Receiving the request for the license information transmitted from the DRM mode converting server 6, the DRM mode selecting section 33 of the license server 2 supplies the request for the license information to the license management section 32.

Receiving the request for the license information from the DRM mode selecting section 33, the license management section 32 of the license server 2 searches for the license data using the contents ID of the request for the license information, and extracts the contents decryption key from the license data.

Then, the license management section 32 encrypts the contents decryption key; encrypts the encryption key employed at the encryption by using the public key stored in the client certificate (the client certificate of the DRM mode converting server 6) included in the request for the license information; generates the response of the license information of the OMA DRM mode together with the information on the encryption scheme; and transmits the response of the license information to the DRM mode conversion reception section 51 of the DRM mode converting server 6 (step ST8).

When the electronic watermark information is impressed in the media, the license management section 32 can also transmit the electronic watermark scheme and the extraction key information using the extended description of the OMA DRM mode.

Here, the contents decryption key and the electronic watermark extraction key received from the license server 2 are transmitted to the control command transfer section 52 of the DRM mode converting server 6 together with the session ID.

Receiving the response of the license information transmitted from the license server 2, the DRM mode conversion reception section 51 of the DRM mode converting server 6 decodes the encryption key of the encrypted contents from the message in the form of the OMA DRM mode; encrypts the encryption key of the contents using the public key of the client terminal 1; and transmits the encryption key to the client terminal 1 (step ST10) as the license information (step ST9).

Likewise, the information about the browsing conditions is also incorporated in the license information. When the type of the electronic watermark and the extraction key information are incorporated, such information items are also encrypted using the public key of the client terminal 1 to be transmitted together as part of the license information.

The DRM mode conversion reception section 51 of the DRM mode converting server 6 transmits the session ID, encryption scheme, decryption key, electronic watermark scheme, extraction key and the like, which are transmitted from the license server 2, to the control command transfer section 52 of the DRM mode converting server 6. In addition, it also transmits the encryption scheme, encryption key, electronic watermark scheme and extraction key, which are transmitted to the client terminal 1, to the control command transfer section 52 of the DRM mode converting server 6.

The DRM mode notification section 12 of the client terminal 1 receives the license information transmitted from the DRM mode converting server 6.

Thus, the license server 2 employing the different DRM mode can transmit to the client terminal 1 the information necessary for decoding the encrypted contents.

Here, the present embodiment 1 is described by way of example in which the client terminal 1 does not store the license information, but receives the license information from the license server 2 and restores it every time the client terminal 1 accesses the multimedia contents. However, it is also possible to employ a method in which the client terminal 1 stores the license information at the time when it accesses the multimedia contents for the first time, and uses the stored license information when it accesses the same multimedia contents for the second and subsequent times, thereby making it unnecessary to download the license information every time.

Receiving the license information transmitted from the DRM mode converting server 6, the DRM mode notification section 12 of the client terminal 1 supplies the control command transmitting/receiving section 13 with the encryption scheme employed and the encrypted contents decryption key together with the information necessary for receiving the contents such as the contents URL. In addition, it transmits the encrypted contents decryption key to the decryption section 15.

As for the electronic watermark scheme and the extraction key, they are supplied to the electronic watermark extracting section 22 via the control command transmitting/receiving section 13 as necessary.

Receiving the URL of the multimedia contents from the DRM mode notification section 12, the control command transmitting/receiving section 13 of the client terminal 1 transmits a request for transmitting the multimedia contents to the DRM mode converting server 6 using the RTSP (step ST11).

Receiving the request for the multimedia contents transmitted from the client terminal 1, the control command transfer section 52 of the DRM mode converting server 6 transfers the request for the multi media contents to the distribution server 4 (step ST12).

Receiving the request for the multimedia contents transmitted from the DRM mode converting server 6, the control command transmitting/receiving section 41 of the distribution server 4 sends the RTSP response, which is a reply to the request, back to the DRM mode converting server 6.

Receiving the RTSP response transmitted from the distribution server 4, the control command transfer section 52 of the DRM mode converting server 6 transfers the RTSP response to the client terminal 1.

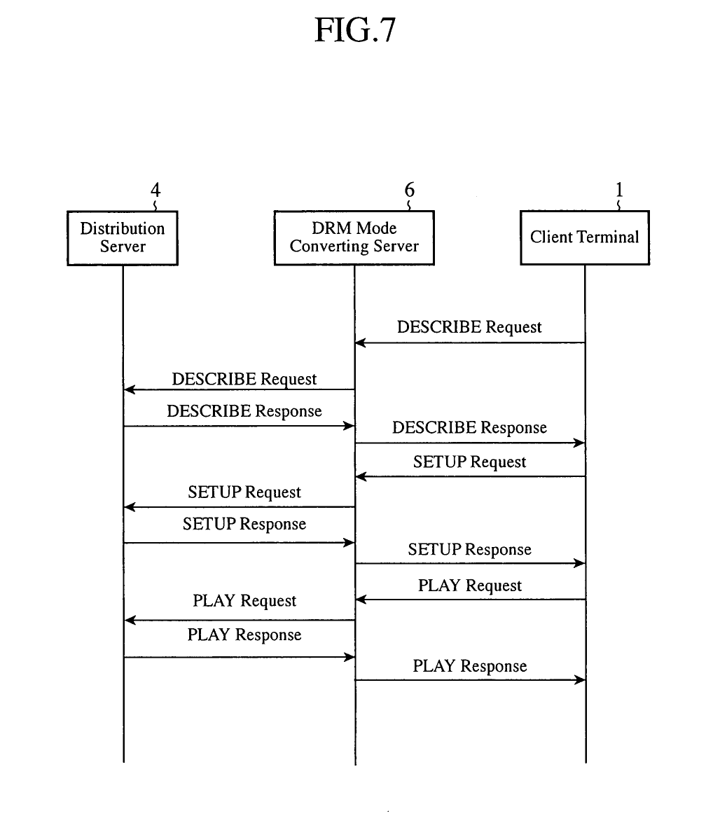

FIG. 7 is a sequence chart illustrating the behavior of the command transfer of the RTSP.

Receiving the RTSP response transmitted from the DRM mode converting server 6, the control command transmitting/receiving section 13 of the client terminal 1 transmits a DESCRIBE request to the DRM mode converting server 6.

Receiving the DESCRIBE request transmitted from the client terminal 1, the control command transfer section 52 of the DRM mode converting server 6 transmits a DESCRIBE request with the same contents as the DESCRIBE request to the distribution server 4.

Receiving the DESCRIBE request transmitted from the DRM mode converting server 6, the control command transmitting/receiving section 41 of the distribution server 4 carries out the processing of the DESCRIBE request, and transmits the DESCRIBE response to the DRM mode converting server 6.

Receiving the DESCRIBE response transmitted from the distribution server 4, the control command transfer section 52 of the DRM mode converting server 6 transfers the DESCRIBE response to the client terminal 1.

After that, in the same manner as described above, the client terminal 1 transmits a SETUP request and a PLAY request to the distribution server 4 via the DRM mode converting server 6; and the distribution server 4 transmits a SETUP response and a PLAY response to the client terminal 1 via the DRM mode converting server 6.

When the multimedia contents of the distribution target are managed by the multimedia contents management DB 5, the stream reading section 42 of the distribution server 4 reads, at the time when the transmission and reception of the PLAY command of the RTSP is completed, the multimedia data constituting the multimedia contents from the multimedia contents management DB 5, and supplies the multimedia data to the packet constructing section 43.

Receiving the encrypted multimedia data from the stream reading section 42, the packet constructing section 43 of the distribution server 4 generates an RTP packet including the encrypted multimedia data.

At this time, the control command transmitting/receiving section 41 controls the encryption of the multimedia data in the packet constructing section 43 using the DRM mode indicated by the license server 2.

Although the description is made here by way of example in which the contents encrypted in advance are managed by the multimedia contents management DB 5, this is not essential. For example, it is also possible for the packet constructing section 43 to encrypt the multimedia data in real time at the transmission when distributing live video or the like.

Incidentally, when the digital rights information and the like is to be impressed into the multimedia contents by means of the digital watermark, it is assume that the multimedia data, into which the electronic watermark information is impressed in advance, is managed by the multimedia contents management DB 5.

When the packet constructing section 43 generates the RTP packet including the multimedia data, the stream transmitting section 44 of the distribution server 4 refers to the time stamp of the RTP packet, and transmits the RTP packet to the DRM mode converting server 6 at the bit rate instructed by the control command transmitting/receiving section 41.

After transmitting the PLAY command of the RTSP, the control command transfer section 52 of the DRM mode converting server 6 transmits to the encryption scheme converting section 54 the encryption scheme and decryption key information transmitted from the license server 2 and the encryption scheme and encryption key transmitted to the client terminal 1; and supplies the watermark scheme converting section 53 with the electronic watermark scheme and extraction key transmitted from the license server 2 and the electronic watermark scheme and extraction key transmitted to the client terminal 1.

The stream transfer section 55 of the DRM mode converting server 6 receives the RTP packet transmitted from the distribution server 4.

The encryption scheme converting section 54 of the DRM mode converting server 6 decodes the encryption of the multimedia data included in the RTP packet received by the stream transfer section 55; and encrypts the multimedia data again in the encryption scheme available to the client terminal 1.

If the encryption schemes or their modes are the same between the distribution server 4 and the DRM mode converting server 6, and between the DRM mode converting server 6 and the client terminal 1, the transmission is also enabled without converting the encryption of the data.

In this case, using the DRM mode the license server 2 and distribution server 4 actually employ, which is decided previously, the DRM mode conversion reception section 51 controls the decoding of the encryption in the encryption scheme converting section 54. In addition, using the DRM mode the client terminal 1 actually employs, which is decided previously, the DRM mode conversion reception section 51 controls the encryption in the encryption scheme converting section 54.

The watermark scheme converting section 53 of the DRM mode converting server 6 extracts the electronic watermark information from the multimedia data included in the RTP packet received from the stream transfer section 55, and impresses the electronic watermark information into the multimedia data again in the impressing scheme of the digital watermark available to the client terminal 1.

In this case, using the DRM mode the license server 2 and distribution server 4 actually employ, which is decided previously, the DRM mode conversion reception section 51 controls the extraction of the electronic watermark information in the watermark scheme converting section 53. In addition, using the DRM mode the client terminal 1 actually employs, which is decided previously, the DRM mode conversion reception section 51 controls the impression of the electronic watermark information in the watermark scheme converting section 53.

When the processing by the encryption scheme converting section 54 and watermark scheme converting section 53 has been completed, the stream transfer section 55 of the DRM mode converting server 6 makes a packet again from the multimedia data passing through the processing, and transmits the RTP packet to the client terminal 1.

The stream receiving section 14 of the client terminal 1 receives the RTP packet transmitted from the DRM mode converting server 6, and supplies the RTP packet to the decryption section 15.

Receiving the RTP packet from the stream receiving section 14, the decryption section 15 of the client terminal 1 decodes the encryption of the multimedia data in the RTP packet; and supplies the video multimedia data to the video decoding section 16 and audio multimedia data to the audio decoding section 19.

Receiving the encoded video multimedia data from the decryption section 15, the video decoding section 16 of the client terminal 1 decodes the multimedia data under the control of the control command transmitting/receiving section 13.

When the video decoding section 16 decodes the multimedia data, the video display section 17 of the client terminal 1 displays the video on the monitor 18 in accordance with the multimedia data.

If the electronic watermark information is impressed into the multimedia data decoded by the video decoding section 16, the electronic watermark extracting section 22 extracts the electronic watermark information from the multimedia data.

Receiving the encoded audio multimedia data from the decryption section 15, the audio decoding section 19 of the client terminal 1 decodes the multimedia data.

When the audio decoding section 19 decodes the multimedia data, the audio output section 20 of the client terminal 1 restores the multimedia data at the timing of the RTP time stamp, thereby causing the audio to be output from the speaker 21.

As is clear from the foregoing description, the present embodiment 1 is configured in such a manner that when the DRM mode indicated by the client terminal 1 differs from the DRM mode available to the license server 2 and distribution server 4, the license server 2 requests the DRM mode converting server 6 to convert the DRM mode in the multimedia contents; and the DRM mode converting server 6, when it receives the conversion request of the DRM mode from the license server 2, converts the DRM mode of the multimedia contents distributed from the distribution server 4 to the DRM mode available to the client terminal 1, and transfers the converted multimedia contents to the client terminal 1. Thus, the present embodiment 1 offers an advantage of being able to distribute the multimedia contents to the client terminal 1 even when the plurality of DRM modes installed in advance do not include the DRM mode available to the client terminal 1.

### Embodiment 2

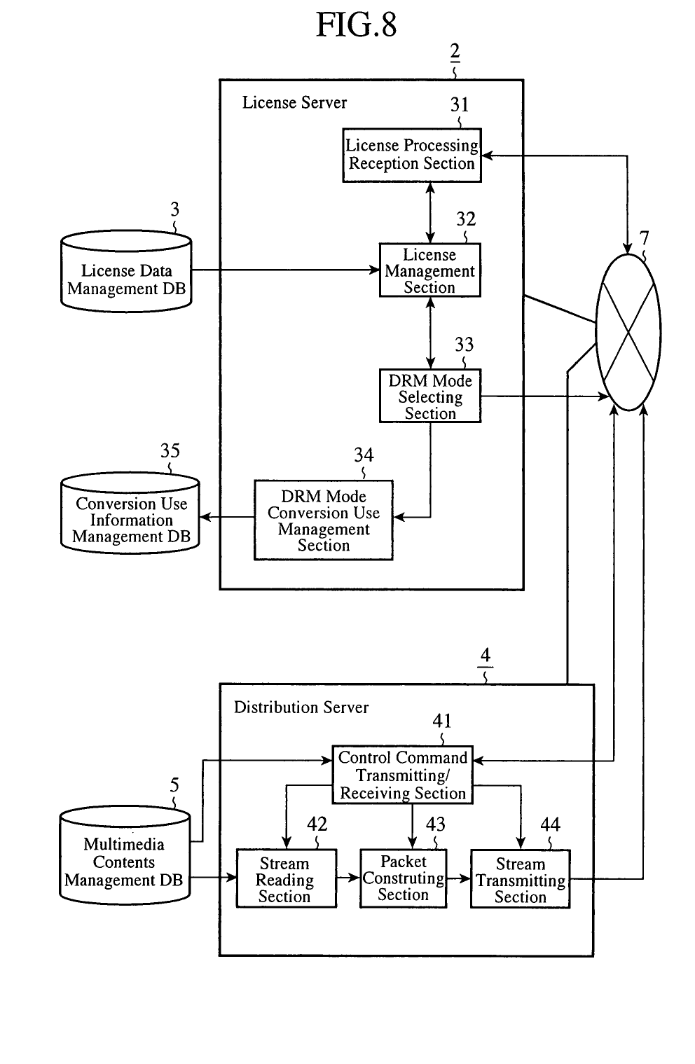

FIG. 8 is a block diagram showing a configuration of the license server 2 and distribution server 4 of the contents distribution system of an embodiment 2 in accordance with the present invention. In FIG. 8, since the same reference numerals as those of FIG. 3 designate the same or like portions, their description will be omitted.

A DRM mode conversion use management section 34 of the license server 2 manages the number of times the conversion request of the DRM mode is transmitted from the DRM mode selecting section 33 to the DRM mode converting server 6, and stores the number of times of the transmission to a conversion use information management DB 35.

The conversion use information management DB 35 of the license server 2 is a database for storing the number of times the conversion request of the DRM mode is transmitted from the DRM mode selecting section 33.

Next, the operation will be described.

In the same manner as in the foregoing embodiment 1, the DRM mode selecting section 33 of the license server 2 makes a decision, when none of the DRM modes available to the client terminal 1 are included in the DRM modes available to itself, that the DRM modes available to the client terminal 1 cannot be used, and transmits the conversion request of the DRM mode of the multimedia contents to the DRM mode converting server 6.

When the DRM mode selecting section 33 transmits the conversion request of the DRM mode to the DRM mode converting server 6, the DRM mode conversion use management section 34 counts up the number of times of the transmission of the conversion request stored in the conversion use information management DB 35.

Alternatively, when the DRM mode selecting section 33 transmits the conversion request of the DRM mode to the DRM mode converting server 6, the DRM mode conversion use management section 34 manages the use information indicating the date and time of the transmission of the conversion request (including the user ID, contents ID and the like); counts up the use information at regular intervals; and stores the number of times of the transmission of the conversion request into the conversion use information management DB 35.

Thus, the DRM mode conversion use management section 34 of the license server 2 can compute the usage charge to be paid to the site operating the DRM mode converting server 6, that is, the usage charge involved in the DRM mode conversion, from the number of times of the transmission of the conversion request.

Accordingly, when the user pays the usage charge of the contents to the site operating the distribution server 4, the user can pay the total fee including the usage charge involved in the DRM mode conversion. This offers an advantage of being able to save time and effort of the user of paying the usage charge involved in the conversion to the site operating the DRM mode converting server 6.

### Embodiment 3

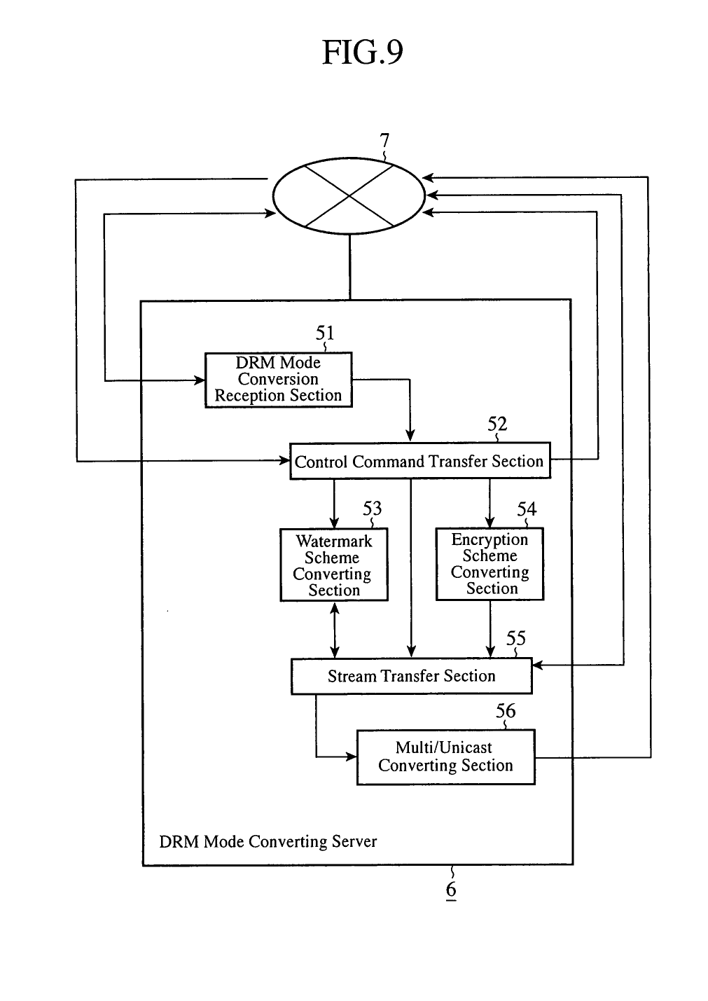

FIG. 9 is a block diagram showing a configuration of the DRM mode converting server 6 of the contents distribution system of an embodiment 3 in accordance with the present invention. In FIG. 9, since the same reference numerals as those of FIG. 4 designate the same or like portions, their description will be omitted.

A multi/unicast converting section 56 converts the distribution mode of the RTP packet, which includes the multimedia data distributed from the distribution server 4, from a multicast mode to a unicast mode.

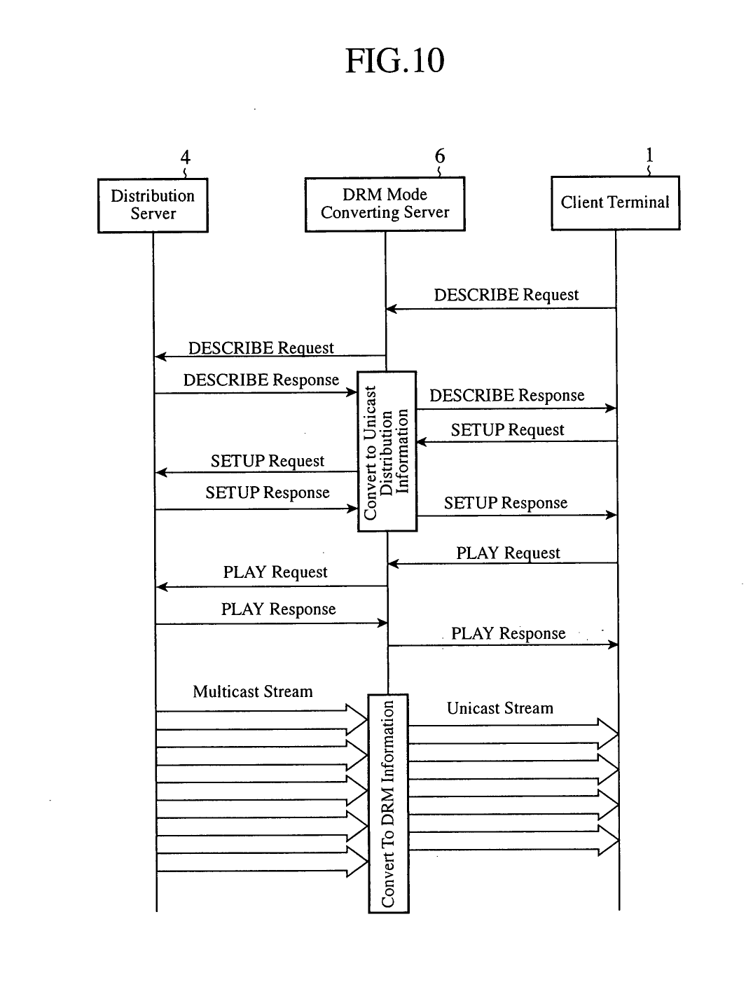

FIG. 10 is a sequence chart illustrating the processing of the conversion from the multicast mode to the unicast mode.

Next, the operation will be described.

After the DRM mode of the multimedia contents is decided, and the license information such as the decryption key is transmitted to the client terminal 1 side in the same manner as in the foregoing embodiment 1, the control command transmitting/receiving section 13 of the client terminal 1 transmits a DESCRIBE request to the DRM mode converting server 6.

Receiving the DESCRIBE request transmitted from the client terminal 1, the control command transfer section 52 of the DRM mode converting server 6 transmits a DESCRIBE request with the same contents as the DESCRIBE request to the distribution server 4.

Receiving the DESCRIBE request transmitted from the DRM mode converting server 6, the control command transmitting/receiving section 41 of the distribution server 4 carries out the processing of the DESCRIBE request, and transmits a DESCRIBE-response to the DRM mode converting server 6.

Receiving the DESCRIBE response transmitted from the distribution server 4, the control command transfer section 52 of the DRM mode converting server 6 refers to the DESCRIBE response, and makes a decision as to whether the distribution mode of the multimedia contents is the multicast mode or not.

When the control command transfer section 52 recognizes that the distribution mode of the multimedia contents is the multicast mode, it converts the information such as the multicast address included in the DESCRIBE response to the information such as the unicast address, and transmits the DESCRIBE response passing through the information conversion to the client terminal 1.

Receiving the DESCRIBE response transmitted from the DRM mode converting server 6, the control command transmitting/receiving section 13 of the client terminal 1 transmits a SETUP request to the DRM mode converting server 6.

Receiving the SETUP request transmitted from the client terminal 1, the control command transfer section 52 of the DRM mode converting server 6 transfers the SETUP request to the distribution server 4.

Receiving the SETUP request transferred from the DRM mode converting server 6, the control command transmitting/receiving section 41 of the distribution server 4 carries out the processing of the SETUP request, and transmits the SETUP response to the DRM mode converting server 6.

Receiving the SETUP response transmitted from the distribution server 4, the control command transfer section 52 of the DRM mode converting server 6 converts the distribution mode of the multimedia contents from the multicast mode to the unicast mode; converts the port number and the like included in the SETUP response to the information of the unicast distribution; and transmits the SETUP response passing through the information conversion to the client terminal 1.

Receiving the SETUP response transmitted from the DRM mode converting server 6, the control command transmitting/receiving section 13 of the client terminal 1 transmits a PLAY request to the DRM mode converting server 6.

Receiving the PLAY request transmitted from the client terminal 1, the control command transfer section 52 of the DRM mode converting server 6 transfers the PLAY request to the distribution server 4.

Receiving the PLAY request transferred from the DRM mode converting server 6, the control command transmitting/receiving section 41 of the distribution server 4 carries out the processing of the PLAY request, and transmits the PLAY response to the DRM mode converting server 6.

Receiving the PLAY response transmitted from the distribution server 4, the control command transfer section 52 of the DRM mode converting server 6 transfers the PLAY response to the client terminal 1.

Receiving the PLAY response transmitted from the DRM mode converting server 6, the control command transmitting/receiving section 13 of the client terminal 1 refers to the PLAY response, and prepares for the unicast reception.

On the other hand, receiving the multimedia data (multicast stream) of the multimedia contents distributed from the distribution server 4, the stream transfer section 55 of the DRM mode converting server 6 supplies the multimedia data to the watermark scheme converting section 53 and encryption scheme converting section 54 in the same manner as in the foregoing embodiment 1.

Receiving the multimedia data, whose mode is converted, from the watermark scheme converting section 53 and encryption scheme converting section 54, the stream transfer section 55 supplies the multimedia data to the multi/unicast converting section 56.

Receiving the multicast stream, which is the multimedia data, from the stream transfer section 55, the multi/unicast converting section 56 of the DRM mode converting server 6 converts the multicast stream to the unicast stream by referring to the unicast address, port number and the like passing through the conversion previously, and transmits the unicast stream to the client terminal 1.

Thus, even if the client terminal 1 differs from the distribution server 4 in the DRM mode available, the present embodiment offers an advantage of being able to convert the multimedia contents, which are distributed by multicast, to the DRM mode corresponding to each client terminal 1 through the DRM mode converting server 6, and to distribute the contents.

According to the present embodiment 3, a method is also possible which converts the DRM mode of the stream distributed by multicast, thereby multicasting again into a different multicast group. In this case, it is also possible for the distribution server 4 or the DRM mode converting server 6 to convert the DRM mode, and to manage the encryption scheme and digital watermark scheme of the DRM mode employed by each stream that is subjected to the multicast distribution, thereby being able to convert to the same DRM mode anew, and to instruct the client terminal 1, which requests the distribution, to receive the stream that has already been multicast.

### Embodiment 4

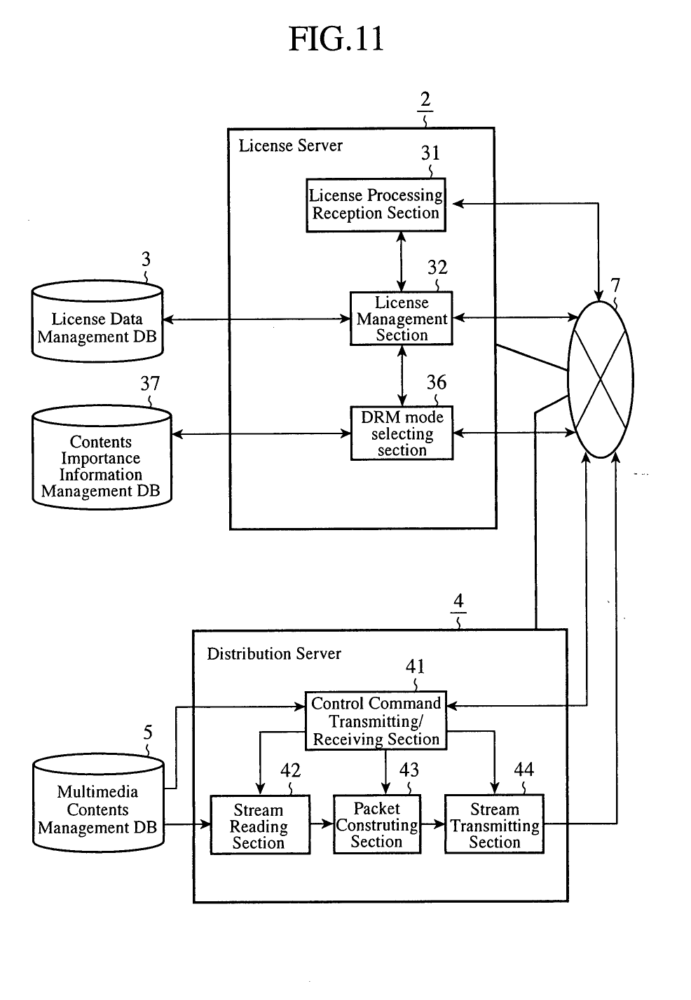

FIG. 11 is a block diagram showing a configuration of the license server 2 and distribution server 4 of the contents distribution system of an embodiment 4 in accordance with the present invention. In FIG. 11, since the same reference numerals as those of FIG. 3 designate the same or like portions, their description will be omitted.

A DRM mode selecting section 36 of the license server 2 carries out the same processing as the DRM mode selecting section 33 of FIG. 3. In addition, when transmitting to the DRM mode converting server 6 the list data of the DRM modes available to the client terminal 1 and the list data of the DRM modes available to the license server 2 and distribution server 4, the DRM mode selecting section 36 transmits to the DRM mode converting server 6 the importance information indicating the importance of the multimedia contents stored in a contents importance information management DB 37.

The contents importance information management DB 37 is a database that manages the importance information indicating the importance of the multimedia contents.

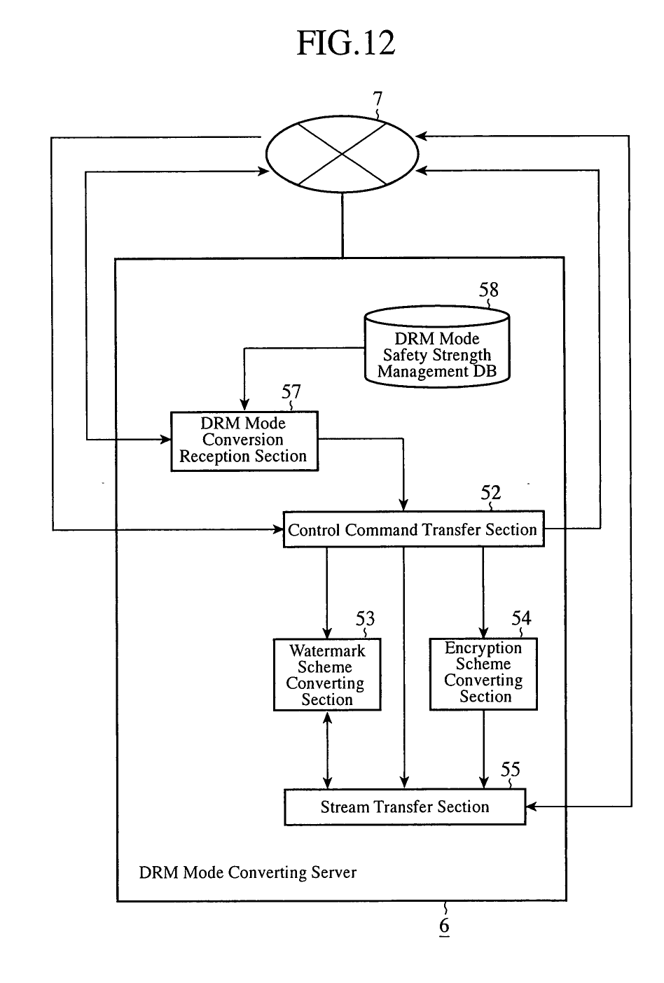

FIG. 12 is a block diagram showing a configuration of the DRM mode converting server 6 of the contents distribution system of the embodiment 4 in accordance with the present invention. In FIG. 12, since the same reference numerals as those of FIG. 4 designate the same or like portions, their description will be omitted.

A DRM mode conversion reception section 57 carries out the same processing as the DRM mode conversion reception section 51 of FIG. 4. In addition, when the encryption scheme and the like employed by the DRM modes available to the client terminal 1 do not have safety strength corresponding to the importance of the multimedia contents distributed from the distribution server 4, the DRM mode conversion reception section 57 carries out the processing of halting the transfer of the multimedia contents to the client terminal 1.

A DRM mode safety strength management DB 58 manages the importance data indicating the safety strength of the encryption scheme and the like used in the DRM modes. Here, the importance data is the data onto which are mapped the types of the DRM modes (such as DRM 1 and DRM 2) and the importance of the contents applicable to the groups of the encryption schemes employed in the DRM modes.

Next, the operation will be described.

When transmitting the conversion request of the DRM mode to the DRM mode converting server 6, the DRM mode selecting section 36 of the license server 2 transmits, in the same manner as in the foregoing embodiment 1, the list data of the DRM modes available to the client terminal 1 and the list data of the DRM modes available to the license server 2 and distribution server 4 to the DRM mode converting server 6.

In addition, the DRM mode selecting section 36 transmits along with the list data the importance information indicating the importance of the multimedia contents stored in the contents importance information management DB 37 to the DRM mode converting server 6.

Receiving the list data of the DRM modes and the importance information transmitted from the license server 2, the DRM mode conversion reception section 57 of the DRM mode converting server 6 decides, in the same manner as in the foregoing embodiment 1, the DRM mode the DRM mode converting server 6 actually employ between it and the client terminal 1, and the DRM mode the license server 2 and distribution server 4 actually employ.

The DRM mode conversion reception section 57, however, differs from that in the foregoing embodiment 1 in that it decides the DRM mode by referring to the importance information transmitted from the license server 2.

More specifically, to decide the DRM mode to be actually used, the DRM mode conversion reception section 57 refers to the DRM mode safety strength management DB 58, and searches for the DRM mode capable of utilizing the encryption scheme and the like having the safety strength corresponding to the importance of the multimedia contents, which is indicated by the importance information transmitted from the license server 2.

In other words, the multimedia contents whose importance is greater than the importance of the contents to which the DRM mode is applicable cannot be distributed using that DRM mode.

For example, assume that the importance increases as the number of importance decreases, and that importance “3” is assigned to the encryption scheme 1 employed in the DRM mode DRM 1. In this case, although contents with importance “4” can be distributed by encrypting the contents with the encryption scheme of the DRM mode, contents with importance “2” cannot be distributed by encrypting the contents with the encryption scheme of the DRM mode. Thus, the DRM mode conversion reception section 57 searches for the DRM mode having the importance data indicating that the importance of the contents to which the DRM mode is applicable is higher than the importance of the multimedia contents.

When the DRM mode is present which has the safety strength corresponding to the importance of the multimedia contents, the DRM mode conversion reception section 57 makes a decision of employing the DRM mode. In contrast, unless the DRM mode is present which has the safety strength corresponding to the importance of the multimedia contents, the DRM mode conversion reception section 57 notifies the distribution server 4 that the multimedia contents cannot be distributed, and halts the distribution preparation processing of the multimedia contents.

As is clear from the foregoing description, the present embodiment 4 is configured in such a manner as to halt the transfer of the multimedia contents to the client terminal 1 when the DRM mode available to the client terminal 1 and distribution server 4 does not have the safety strength corresponding to the importance of the multimedia contents distributed from the distribution server 4. Accordingly, the present embodiment offers an advantage of being able to prevent the multimedia contents, whose digital rights must be protected with great security, from being converted to the DRM mode with lower safety strength and distributed.

### Embodiment 5

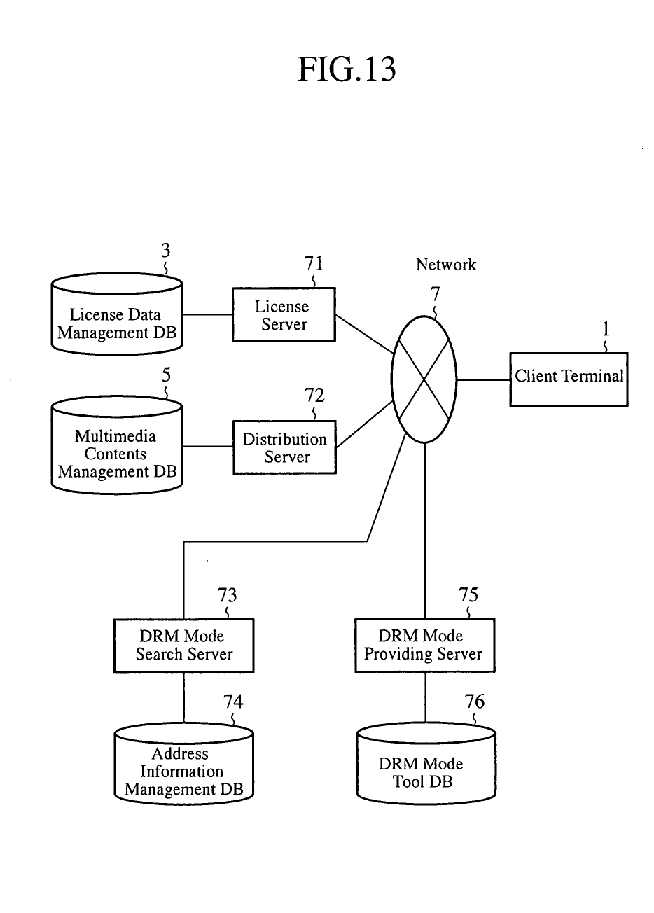

FIG. 13 is a block diagram showing a configuration of the contents distribution system of an embodiment 5 in accordance with the present invention. In FIG. 13, since the same reference numerals as those of FIG. 1 designate the same or like portions, their description will be omitted.

A license server 71, when the DRM mode indicated by the client terminal 1 differs from the DRM modes available to itself, requests to download a DRM mode tool capable of implementing the DRM mode indicated by the client terminal 1, and receives the DRM mode tool.

A distribution server 72 carries out the DRM mode tool received by the license server 71, and distributes the multimedia contents to the client terminal 1.

Here, the license server 71 and distribution server 72, which constitute a contents distribution apparatus, can be installed within the same provider or in different providers.

Receiving the DRM mode from the license server 71, a DRM mode search server 73 searches for a DRM mode providing server 75 capable of providing the DRM mode tool for implementing the DRM mode, and sends the address information of the DRM mode providing server 75 back to the license server 71.

An address information management DB 74 is a database for managing the address information of the DRM mode providing server 75 that provides the DRM mode tool.

Receiving the DRM mode from the license server 71, the DRM mode providing server 75 sends the metadata describing directions for using the DRM mode tool corresponding to the DRM mode back to the license server 71. The DRM mode tool includes a plurality of functions such as a communication function and an encryption function of the DRM mode.

A DRM mode tool DB 76 is a database that manages DRM mode tools and metadata describing directions for using them.

Here, the DRM mode search server 73 and DRM mode providing server 75 constitute a DRM mode providing apparatus.

The foregoing embodiments 1-4 are described by way of example which has the DRM mode converting server 6 convert the DRM mode of the multimedia contents, and which carries out the stream distribution of the multimedia contents. However, in the case where the client terminal 1 notifies the license server 71 of the DRM modes available to the client terminal 1, and where the DRM modes available to the license server 71 and distribution server 72 differ from the DRM modes available to the client terminal 1, the license server 71 can acquire the DRM mode tool available to the client terminal 1 from the network, and carry out the stream distribution of the multimedia contents using the DRM mode.

It is assumed in the present embodiment 5 that the user can purchase the browsing right of the multimedia contents the distribution server 72 provides, and browse the multimedia contents by streaming until the expiration of the validity time. Alternatively, it is assumed that the user can browse the multimedia contents by the designated number of times.

In addition, as for the protocols other than the DRM mode, it is assumed that the client terminal 1, license server 71 and distribution server 72 employ the same standard protocols, thereby making it possible to connect them.

As in the foregoing embodiments 1-4, it is assumed that the stream distribution protocol of the media employs the RTP, and the stream control protocol such as a start, pause and stop of the reproduction employs the RTSP.

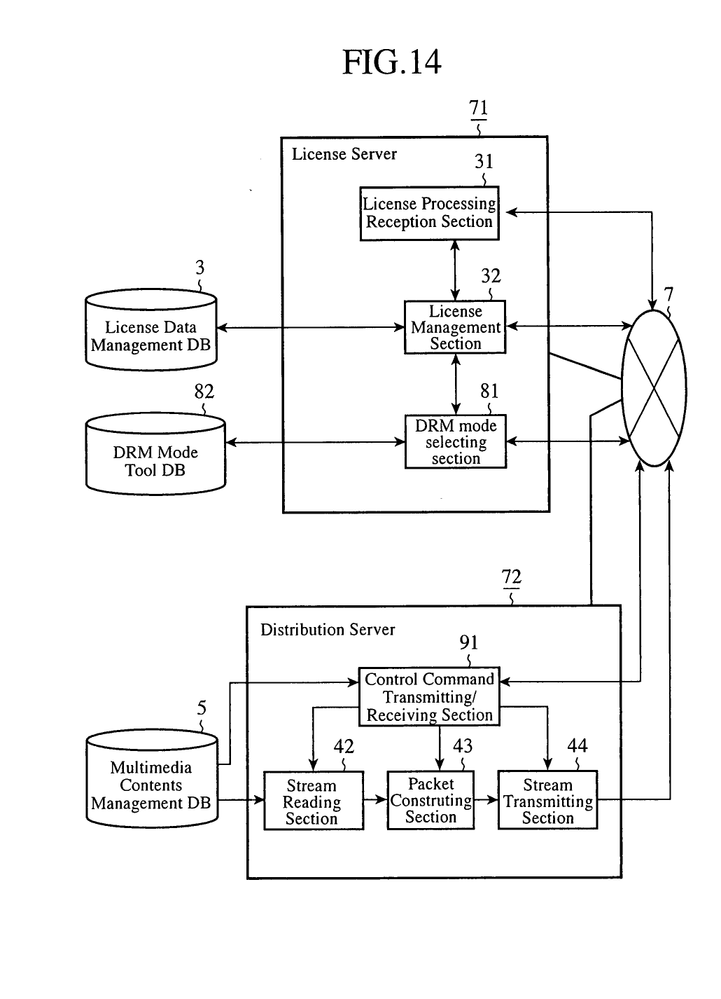

FIG. 14 is a block diagram showing a configuration of the license server 71 and distribution server 72 of the contents distribution system of an embodiment 5 in accordance with the present invention. In FIG. 14, since the same reference numerals as those of FIG. 3 designate the same or like portions, their description will be omitted.

A DRM mode selecting section 81 of the license server 71, when the DRM mode indicated by the client terminal 1 differs from the DRM modes available to itself, requests to download the DRM mode tool implementing the DRM mode indicated by the client terminal 1, and receives the DRM mode tool.

A DRM mode tool DB 82 is a database that manages the DRM modes available to the license server 71.

A control command transmitting/receiving section 91 of the distribution server 72 carries out the DRM mode tool received from the DRM mode selecting section 81 of the license server 71, and controls the stream reading section 42, packet constructing section 43 and stream transmitting section 44.

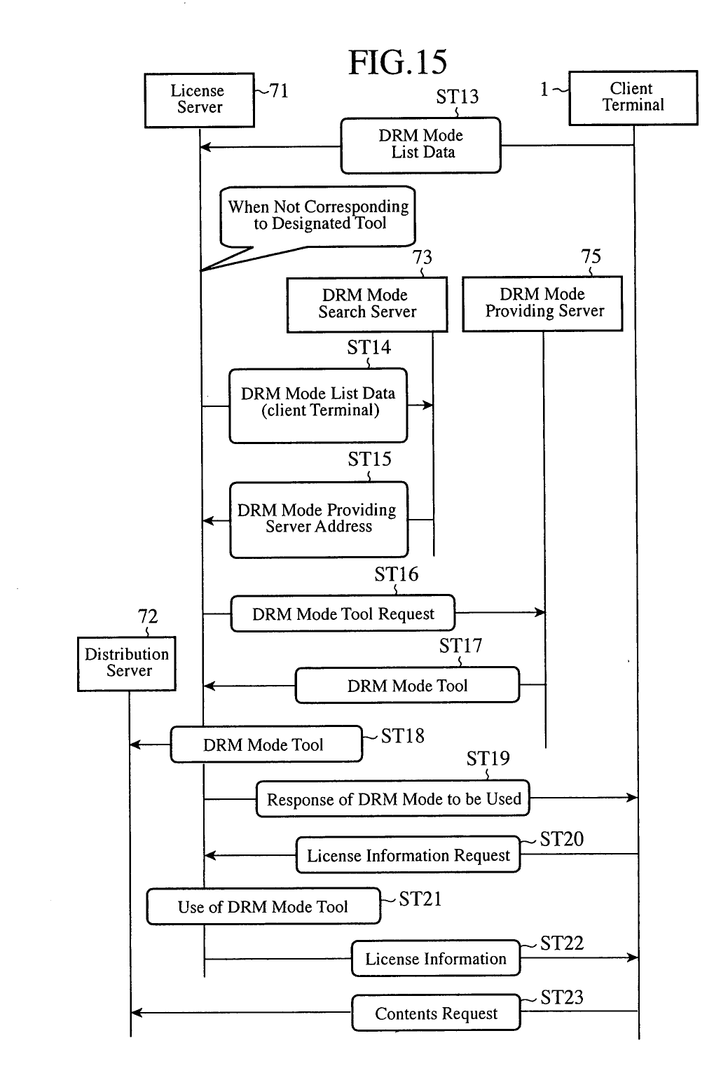

FIG. 15 is a sequence chart illustrating the processing of the contents distribution system of the embodiment 5 in accordance with the present invention.

Next, the operation will be described.

As for the user authentication between the client terminal 1 and the license server 71, and the list display processing of the available contents, they are the same as those of the foregoing embodiment 1.

In addition, as for the processing in which the user selects the browsing-desired multimedia contents, and the client terminal 1 reports the list data of its available DRM modes to the license server 71, it is the same as that of the foregoing embodiment 1.

When the DRM mode selecting section 81 of the license server 71 receives the list data of the available DRM modes from the client terminal 1 in the same manner as in the foregoing embodiment 1 (step ST13 of FIG. 15), it checks whether the DRM mode available to the license server 71 and distribution server 72 is present in the DRM modes in the list data.

When the DRM mode available to the license server 71 and distribution server 72 is present in the DRM modes available to the client terminal 1, the DRM mode selecting section 81 selects the DRM mode to be actually used, and notifies the client terminal 1 of it.

Thus, the distribution of the multimedia contents is carried out using the DRM mode.

On the other hand, unless the DRM mode available to the license server 71 and distribution server 72 is present in the DRM modes available to the client terminal 1, the distribution server 72 cannot carry out the contents distribution of the multimedia. Thus, it downloads the tool of the DRM modes available to the client terminal 1 from the network.

The following is the concrete description thereof.

To search for the DRM mode providing server 75 capable of providing the tool of the DRM modes available to the client terminal 1, the DRM mode selecting section 81 of the license server 71 accesses the DRM mode search server 73, and requests it to search for the address information of the DRM mode providing server 75 by transmitting the DRM modes available to the client terminal 1 to the DRM mode search server 73 (step ST14).

Receiving the DRM modes from the license server 71, the DRM mode search server 73 searches for the DRM mode providing server 75 capable of providing the tool of the DRM modes available to the client terminal 1 from the address information management DB 74 using the DRM modes as a key.

Then, the DRM mode search server 73 sends the address information of the DRM mode providing server 75 back to the license server 71 (step ST15).

Receiving the address information of the DRM mode providing server 75 sent back from the DRM mode search server 73, the DRM mode selecting section 81 of the license server 71 refers to the address information, accesses the DRM mode providing server 75, and transmits the DRM modes available to the client terminal 1 to the DRM mode providing server 75, thereby requesting to download the DRM mode tool (step ST16).

Receiving the DRM modes from the license server 71, the DRM mode providing server 75 searches for the tool of the DRM modes available to the client terminal 1 and the metadata describing directions for using the tool from the DRM mode tool DB 76 using the DRM modes as a key.

Then, the DRM mode providing server 75 sends the DRM mode tool and the metadata back to the license server 71 (step ST17).

Here, the metadata describing directions for using the DRM mode tool is data describing the functions of the DRM mode tool, the directions for using the functions and using timings, and the information about interfaces.

For example, the metadata includes, for each function of the DRM mode tool, the contents of the function (such as transmission and reception of the license information, encryption, and watermark impression), application media (such as video or audio), application encoding scheme (such as MPEG-4, MPEG-2, or common encoding scheme), using timing (such as before encoding, after encoding, or after packeting) and interface.

As for the interface, the number of parameters of the interface, the code expressing each parameter and the like are specified. The code denoting each parameter is defined for each function of the DRM mode tool. For example, when the function of the DRM mode is encryption, there are assigned plaintext data, encryption data, encryption key length, encryption key, block length, cryptographic mode as the codes for the parameters.

Accordingly, the processing can be achieved by generating the data at the timing described in the metadata, and by exchanging the data by Socket communication, for example.

Receiving the DRM mode tool and the metadata from the DRM mode providing server 75, the DRM mode selecting section 81 of the license server 71 stores the DRM mode tool in the DRM mode tool DB 82.

As in the foregoing embodiment 1, the license server 71 can cope with the DRM mode of the DRM mode Ver.2 employed by OMA (Open Mobile Alliance).

In addition, it is assumed that the client terminal 1 employs a system in which when the client side transmits the client certificate to the server side, the server side encrypts the encryption key of the contents using the public key of the client terminal 1, and transmits it.

The license server 71 notifies the client terminal 1 of the DRM mode decided to be actually used (step ST19).

Subsequently, the license server 71 refers to the metadata indicating the using method of the DRM mode tool, and when a license information transmission and reception function is present in the DRM mode tool received, the DRM mode selecting section 81 of the license server 71 waits for receiving the data from the client terminal 1.

When the communication from the client terminal 1 arrives (step ST20), the DRM mode selecting section 81 of the license server 71 transfers the received data to the license information transmission and reception function of the DRM mode tool (step ST21).

The license information transmission and reception function of the DRM mode tool analyzes the license information request message from the client terminal 1, and sends the data such as the contents ID and client certificate requested back to the DRM mode selecting section 81.

The DRM mode selecting section 81 searches for the license information about the contents requested of the license management section 32, and transfers the browsing conditions and the like to the license information transmission and reception function of the DRM mode tool.

The license information transmission and reception function of the DRM mode tool, using the protocol of the DRM mode the client terminal 1 employs, sends back the license information including the decryption key of the contents and browsing conditions (step ST22).

Here, the decryption key transmitted to the client terminal 1 is not the decryption key of the stored encryption contents, but the decryption key used in the encryption in accordance with the encryption scheme available to the DRM mode the client terminal 1 employs.

The license information transmission and reception function of the DRM mode tool sends the decryption key, which is transmitted to the client terminal 1, back to the DRM mode selecting section 81 of the license server 71.

When the license information-related communication has been completed, the DRM mode selecting section 81 transmits to the distribution server 72 the contents ID, the DRM mode tool and the metadata describing the using method. In addition, it transmits to the distribution server 72 the decoding key of the contents stored, the encryption scheme used for the transmission to the client terminal 1, the encryption key (identical to the decoding key because a common key encryption scheme is employed), and the data necessary for the session ID and the like.

Receiving the necessary information such as the DRM mode tool, metadata and encryption key transmitted from the license server 71, the control command transmitting/receiving section 91 of the distribution server 72 analyzes the metadata to make a decision as to which portions of the stream reading section 42, packet constructing section 43 and stream transmitting section 44 the DRM mode tool is applicable, and transfers the DRM mode tool to these portions.

Receiving from the control command transmitting/receiving section 91 the DRM mode tool of the encryption scheme, the metadata, the decoding key of the multimedia data, the encryption scheme used at the transmission to the client terminal 1, and the encryption key, the packet constructing section 43 decrypts the cryptogram of the multimedia data read by the stream reading section 42 using the decoding key, and encrypts again with the encryption key using the encryption function of the DRM mode tool.

Receiving the license information data necessary for the contents reproduction, the client terminal 1 transmits the contents distribution request to the distribution server 72 using the RTSP (step ST23).

The stream reading section 42, packet constructing section 43 and stream transmitting section 44, when receiving the DRM mode tool from the DRM mode selecting section 81, carry out the DRM mode tool at the designated timing, thereby enabling the distribution of the multimedia contents with protecting the digital rights in the form the client terminal 1 can reproduce.

Thus, as for the multimedia data transmitted in the RTP packet, the client-terminal 1 can decrypt its encryption, and restore it.

Here, the present embodiment 5 is described by way of example in which the client terminal 1 does not store the license information, but receives the license information from the license server 71 and restores it every time the client terminal 1 accesses the multimedia contents. However, it is also possible to employ a method in which the client terminal 1 stores the license information at the time when it accesses the multimedia contents for the first time, and uses the stored license information when it accesses the same multimedia contents for the second and subsequent times, thereby making it unnecessary to download the license information every time.

As is clear from the foregoing description, the present embodiment 5 is configured in such a manner that when the DRM mode indicated by the client terminal 1 differs from the DRM modes available to itself, the license server 71 requests to download the DRM mode tool capable of implementing the DRM mode indicated by the client terminal 1, and when it receives the DRM mode tool, it carries out the DRM mode tool and distributes the multimedia contents to the client terminal 1. Thus, the present embodiment 5 offers an advantage of being able to distribute the multimedia contents to the client terminal 1 even when none of the plurality of DRM modes installed in advance include the DRM modes available to the client terminal 1.

### Embodiment 6

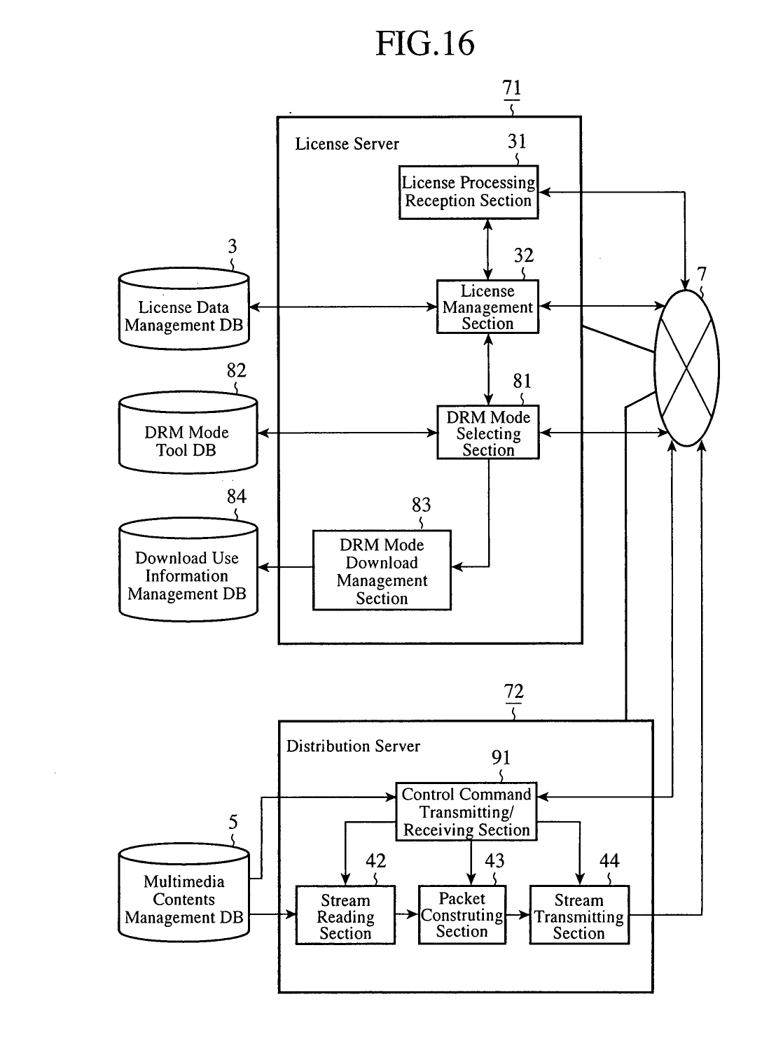

FIG. 16 is a block diagram showing a configuration of the license server 71 and distribution server 72 of the contents distribution system of an embodiment 6 in accordance with the present invention. In FIG. 16, since the same reference numerals as those of FIG. 14 designate the same or like portions, their description will be omitted.

A DRM mode download management section 83 of the license server 71 stores in a download use information management DB 84 the number of times the download request of the DRM mode tool is transmitted from the DRM mode selecting section 81.

The download use information management DB 84 of the license server 71 is a database that stores the number of times the download request is transmitted from the DRM mode selecting section 81.

Next, the operation will be described.

In the same manner as in the foregoing embodiment 5, the DRM mode selecting section 81 of the license server 71 makes a decision, when none of the DRM modes available to the client terminal 1 are included in the DRM modes available to itself, that the DRM modes available to the client terminal 1 cannot be used, and transmits the download request of the DRM mode tool to the DRM mode providing server 75.

When the DRM mode selecting section 81 transmits the download request of the DRM mode tool to the DRM mode providing server 75, the DRM mode download management section 83 of the license server 71 counts up the number of times of the transmission of the download request, which is stored in the download use information management DB 84.

Alternatively, when the DRM mode selecting section 81 transmits the download request of the DRM mode tool to the DRM mode providing server 75, the DRM mode download management section 83 manages the use information indicating the date and time of the transmission of the download request; counts up the use information at regular intervals; and stores the number of times of the transmission of the download request in the download use information management DB 84.

Thus, the DRM mode download management section 83 of the license server 71 can compute the usage charge to be paid to the site operating the DRM mode providing server 75, that is, the usage charge involved in providing the tool by the DRM mode providing server 75, from the number of times of the transmission of the download request.

Accordingly, when the user pays the usage charge of the contents to the site operating the distribution server 72, the user can pay the total fee including the usage charge involved in providing the tool. This offers an advantage of enabling the user to save time and effort of paying the usage charge involved in the tool offering to the site operating the DRM mode providing server 75.

### Embodiment 7

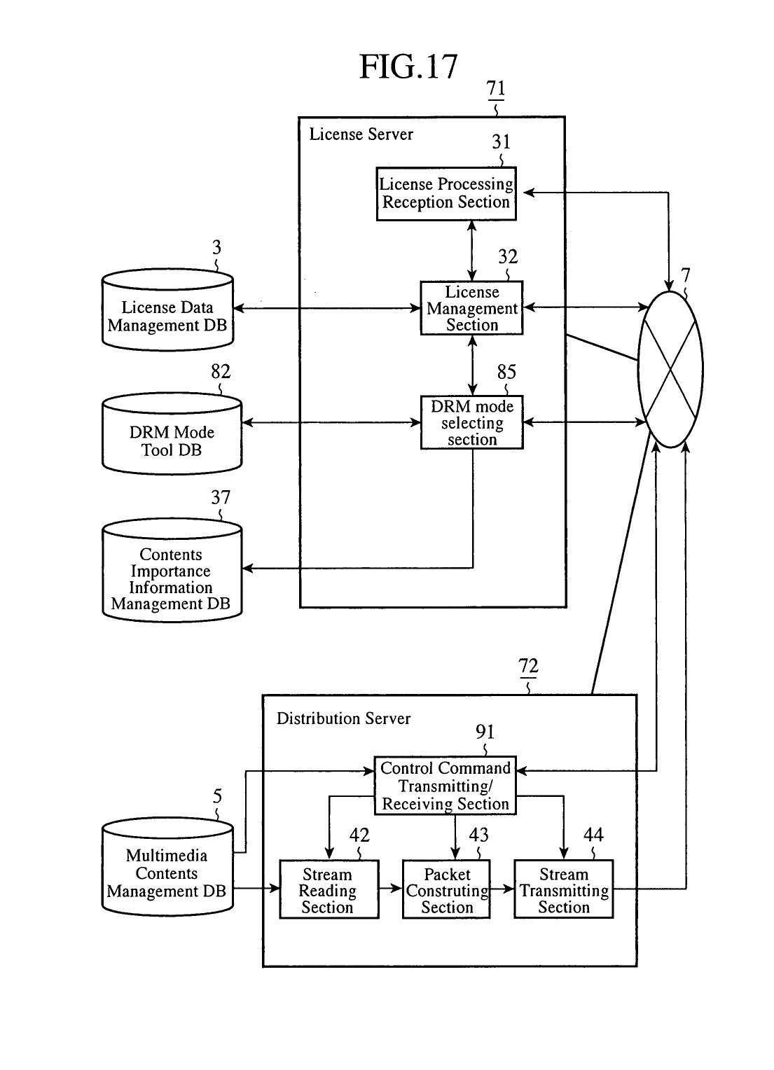

FIG. 17 is a block diagram showing a configuration of the license server 71 and distribution server 72 of the contents distribution system of an embodiment 7 in accordance with the present invention. In FIG. 17, since the same reference numerals as those of FIG. 11 and FIG. 14 designate the same or like portions, their description will be omitted.

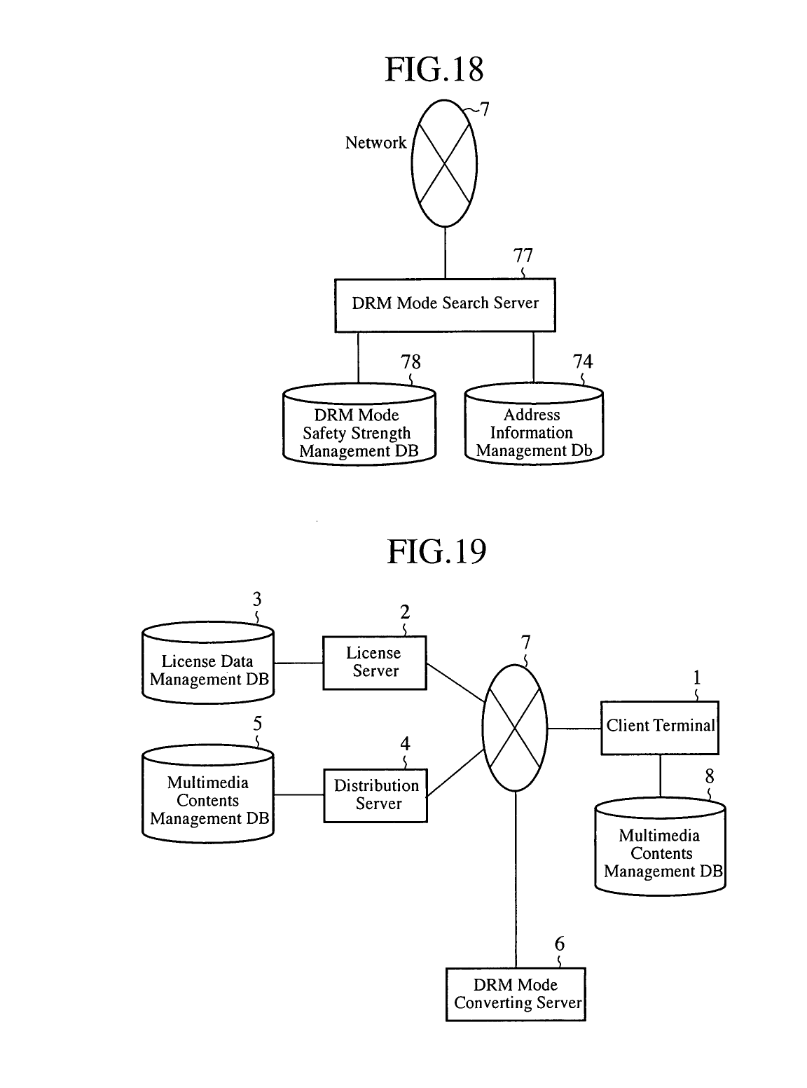

A DRM mode selecting section 85 of the license server 71 carries out the same processing as the DRM mode selecting section 81 of FIG. 14. In addition, when making an address information search request to the DRM mode search server 77 of FIG. 18, the DRM mode selecting section 85 transmits to the DRM mode search server 77 the importance information indicating the importance of the multimedia contents stored in the contents importance information management DB 37.

FIG. 18 is a block diagram showing a major portion of the contents distribution system of an embodiment 7 in accordance with the present invention. In FIG. 18, since the same reference numerals as those of FIG. 13 designate the same or like portions, their description will be omitted.

The DRM mode search server 77 carries out the same processing as the DRM mode search server 73 of FIG. 13. In addition, when the DRM mode available to the client terminal 1 does not have the safety strength corresponding to the importance of the multimedia contents, the DRM mode search server 77 carries out the processing of halting the transmission of the DRM mode tool to the license server 71.

A DRM mode safety strength management DB 78 manages the importance data indicating the safety strength of the DRM modes. Here, the importance data is the data onto which are mapped the DRM modes and the importance of the contents applicable to the groups of the encryption schemes employed in the DRM modes.

Next, the operation will be described.

When making the address information search request to the DRM mode search server 77, the DRM mode selecting section 85 of the license server 71 transmits the DRM mode to the DRM mode search server 77 in the same manner as in the foregoing embodiment 6.

In addition, the DRM mode selecting section 85 transmits along with the DRM mode the importance information indicating the importance of the multimedia contents stored in the contents importance information management DB 37 to the DRM mode search server 77.

Receiving the DRM mode from the license server 71, the DRM mode search server 77 searches for the address information of the DRM mode providing server 75 in the same manner as in the foregoing embodiment 5.

Here, the DRM mode search server 77 differs from its counterpart in the foregoing embodiment 5 in that it refers to the importance information transmitted from the license server 71 to search for the address information of the DRM mode providing server 75.

More specifically, when searching for the address information of the DRM mode providing server 75, the DRM mode search server 77 refers to the DRM mode safety strength management DB 78, and search for the DRM mode providing server 75 offering the DRM mode tool having the safety strength corresponding to the importance of the multimedia contents indicated by the importance information transmitted from the license server 71.

In other words, the multimedia contents having the importance greater than the importance of the contents to which the DRM mode is applicable cannot be distributed using that DRM mode.

For example, assume that the importance increases as the number of importance decreases. In this case, if the importance corresponding to the selected DRM mode and the encryption scheme used therein is “3”, the contents with importance “4” can be encrypted by the encryption scheme and distributed. However, the contents with importance “2” cannot be distributed by encrypting the contents by the encryption scheme.

For this reason, the DRM mode search server 77 searches for the DRM mode providing server 75 that provides the DRM mode having the importance data indicating that the importance of the contents to which the DRM mode is applicable is higher than the importance of the multimedia contents.

When the DRM mode providing server 75 is present which provides the DRM mode having the safety strength corresponding to the importance of the multimedia contents, the DRM mode search server 77 transmits the address information of the DRM mode providing server 75 to the license server 71. In contrast, unless the DRM mode providing server 75 is present which provides the DRM mode having the safety strength corresponding to the importance of the multimedia contents, the DRM mode search server 77 notifies the license server 71 that it cannot transmit the address information of the DRM mode providing server 75, and halts the distribution preparation processing of the multimedia contents.

As is clear from the foregoing description, the present embodiment 7 is configured in such a manner as to halt the transmission of the DRM mode tool to the license server 71 when the DRM mode available to the client terminal 1 does not have the safety strength corresponding to the importance of the multimedia contents. Accordingly, the present embodiment 7 offers an advantage of being able to prevent the multimedia contents, whose digital rights must be protected with great security, from being distributed by the DRM mode with lower safety strength.

### Embodiment 8

Although the foregoing embodiments 1-7 are described by way of example in which the client terminal 1 browses the multimedia contents by carrying out the streaming, the client terminal 1 can browse the multimedia contents after downloading and storing the multimedia contents.

FIG. 19 is a block diagram showing a configuration of the contents distribution system of an embodiment 8 in accordance with the present invention. In FIG. 19, since the same reference numerals as those of FIG. 1 designate the same or like portions, their description will be omitted.

A multimedia contents management DB 8 is a database that manages the multimedia contents downloaded by the client terminal 1.

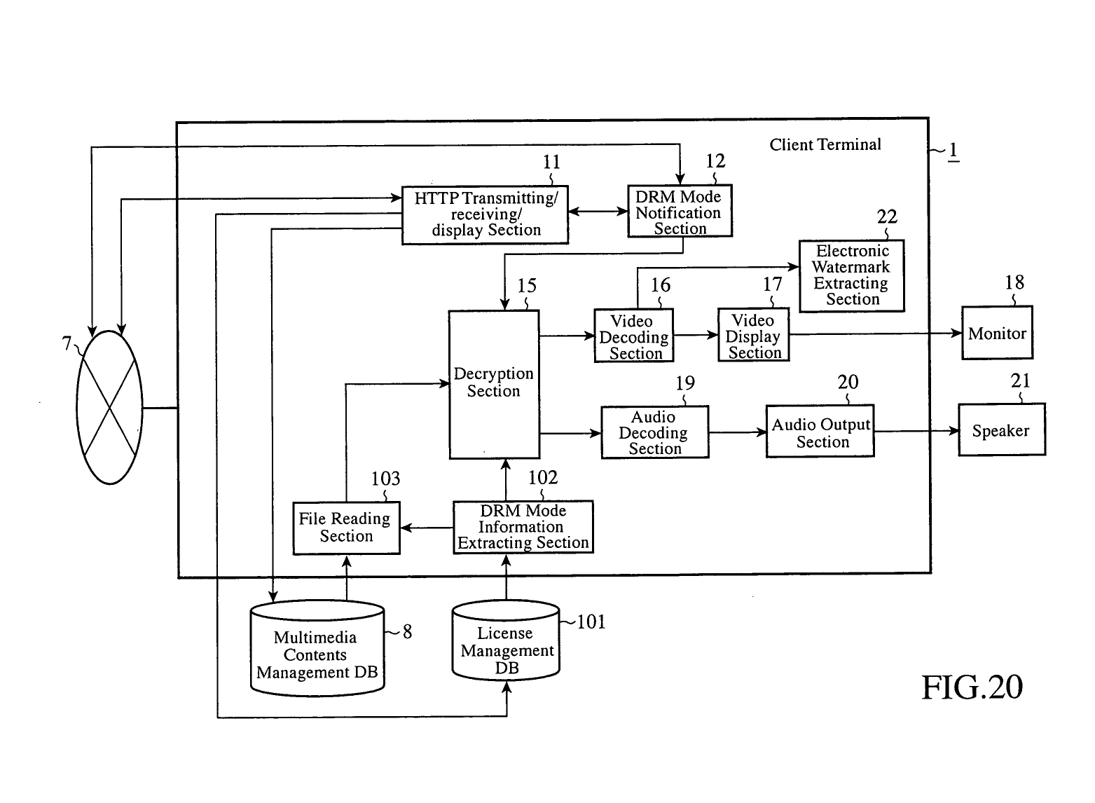

FIG. 20 is a block diagram showing a configuration of the client terminal 1 of the contents distribution system of the embodiment 8 in accordance with the present invention. In FIG. 20, since the same reference numerals as those of FIG. 2 designate the same or like portions, their description will be omitted.

A license management DB 101 is a database that manages the license information the user acquires.

A DRM mode information extracting section 102 carries out the processing of extracting the DRM mode information from the license information managed by the license management DB 101.

A file reading section 103 carries out the processing of reading the multimedia contents stored in the multimedia contents management DB 8.

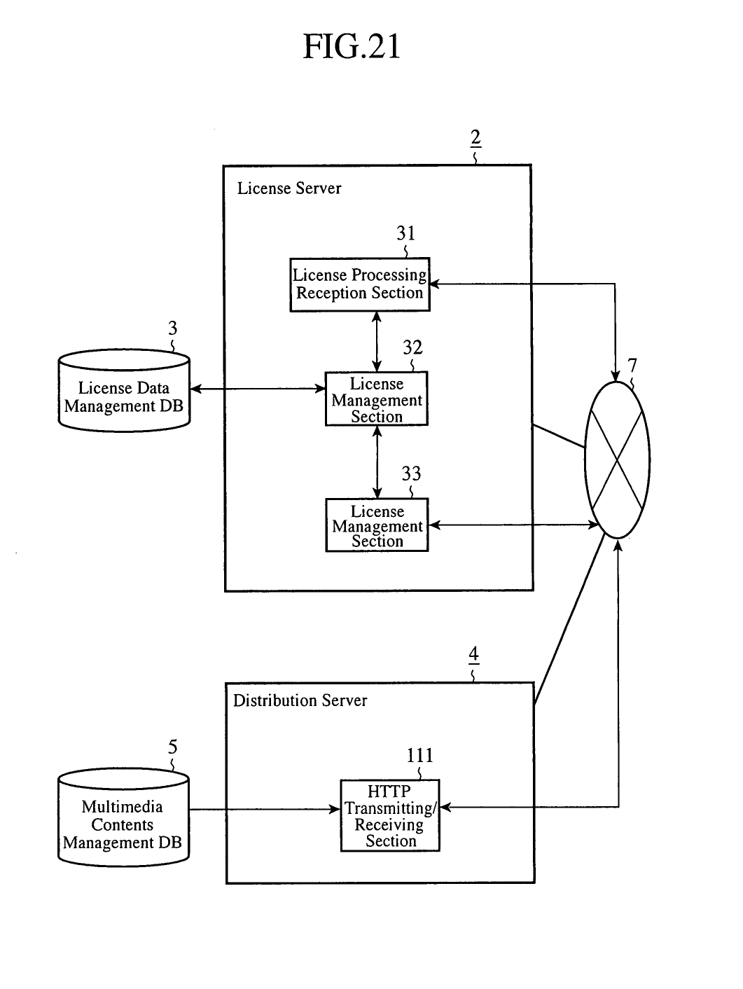

FIG. 21 is a block diagram showing a configuration of the license server 2 and distribution server 4 of the contents distribution system of the embodiment 8 in accordance with the present invention. In FIG. 21, since the same reference numerals as those of FIG. 3 designate the same or like portions, their description will be omitted.

An HTTP transmitting/receiving section 111 of the distribution server 4 carries out the processing of distributing the multimedia contents in the multimedia contents management DB 5.

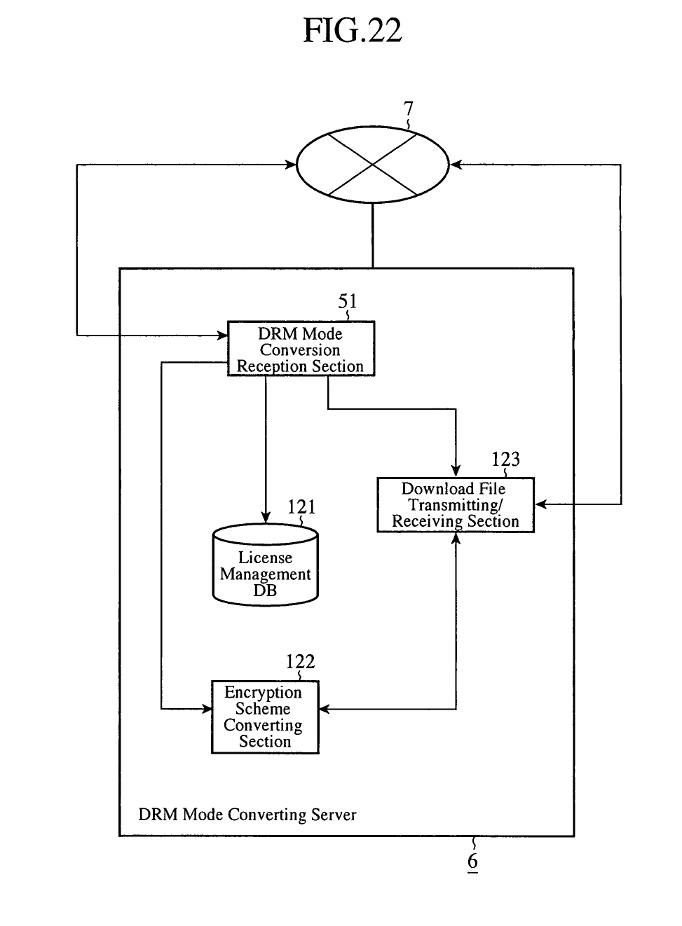

FIG. 22 is a block diagram showing a configuration of the DRM mode converting server 6 of the contents distribution system of the embodiment 8 in accordance with the present invention. In FIG. 22, since the same reference numerals as those of FIG. 4 designate the same or like portions, their description will be omitted.

A license management DB 121 is a database that manages the license information.

An encryption scheme converting section 122, when the DRM mode conversion reception section 51 accepts the conversion request of the DRM mode, decrypts the encryption of the multimedia data included in the packet distributed from the distribution server 4 under the control of the DRM mode conversion reception section 51, and carries out the processing of encrypting the multimedia data again in the encryption scheme available to the client terminal 1.

A download file transmitting/receiving section 123 carries out the processing of transmitting to the client terminal 1 the packet including the multimedia data encrypted again by the encryption scheme converting section 122 under the control of the DRM mode conversion reception section 51.

Next, the operation will be described.

As for the contents list display and the contents selection in the client terminal 1, they are the same as those of the embodiment 1.

When the HTTP transmitting/receiving/display section 11 receives the contents ID and registration completed notification transmitted from the license server 2, the DRM mode notification section 12 of the client terminal 1 transmits the list data of the DRM modes available to the client terminal 1 to the license server 2.

As for the details of the communication contents at deciding the DRM mode, they are performed in accordance with the sequence of FIG. 5 as in the foregoing embodiment 1.

It is assumed in the present embodiment 8, however, that the contents request is made using the HTTP rather than the RTSP. In addition, a portion for storing the license information in the client terminal 1 side is different.

As the foregoing embodiment 1, the client terminal 1 receives the license information transmitted from the license server 2 with converting it to the DRM mode available to the client terminal 1 within the DRM mode converting server 6.

Receiving the license information transmitted from the DRM mode converting server 6, the DRM mode notification section 12 of the client terminal 1 sends the license information, contents URL and session ID to the HTTP transmitting/receiving/display section 11.

The HTTP transmitting/receiving/display section 11, receiving the license information and contents URL from the DRM mode notification section 12, stores the license information in the license management DB 101.

In addition, the HTTP transmitting/receiving/display section 11 transmits a request for the desired contents, user ID and session ID to the DRM mode converting server 6.

Receiving the request for the desired contents, user ID and session ID transmitted from the client terminal 1, the download file transmitting/receiving section 123 of the DRM mode converting server 6 transmits the user ID, session ID and contents ID to the distribution server 4 by using the HTTP, and transmits a contents retrieval request to the distribution server 4.

Receiving the user ID, session ID and contents ID transmitted from the DRM mode converting server 6, and receiving the contents retrieval request therefrom, the HTTP transmitting/receiving section 111 of the distribution server 4 retrieves the multimedia contents corresponding to the contents ID from the multimedia contents management DB 5 by using the contents ID, and transmits the multimedia contents to the DRM mode converting server 6.

Receiving the multimedia contents transmitted from the distribution server 4, the download file transmitting/receiving section 123 of the DRM mode converting server 6 supplies the multimedia data of the multimedia contents to the encryption scheme converting section 122.

Receiving the multimedia data from the download file transmitting/receiving section 123, the encryption scheme converting section 122 of the DRM mode converting server 6 decodes the multimedia data using the decryption key stored in the license information transmitted from the license server 2, and encrypts the plaintext multimedia data in the encryption scheme used by the DRM mode available to the client terminal 1.

The encryption scheme converting section 122, encrypting the multimedia data again, supplies the multimedia data to the download file transmitting/receiving section 123.

The download file transmitting/receiving section 123 of the DRM mode converting server 6, receiving the multimedia data from the encryption scheme converting section 122, transmits the multimedia data constituting the multimedia contents to the client terminal 1.

The HTTP transmitting/receiving/display section 11 of the client terminal 1, receiving the multimedia contents transmitted from the DRM mode converting server 6, stores the multimedia contents in the multimedia contents management DB 8.

After completing the download of the multimedia contents, the file reading section 103 of the client terminal 1 selects desired multimedia contents from the multimedia contents management DB 8, and reads the multimedia contents.

In this case, the file reading section 103 extracts the license information from the license management DB 101 via the DRM mode information extracting section 102, searches the license information for the conditions such as the term of validity or the number of times of the reproduction for the user who wishes the browsing of the multimedia contents, and checks whether it is in a reproduction enabled state or not this time.

If in the reproduction enabled state this time, the file reading section 103 supplies the multimedia contents to the decryption section 15.

Receiving the multimedia contents from the file reading section 103, the decryption section 15 of the client terminal 1 extracts the decryption key of the cryptograph in the license information corresponding to the multimedia contents from the license management DB 101 via the DRM mode information extracting section 102, and decrypts the encryption of the multimedia contents using the decryption key.

Here, the license information is encrypted using the public key of the client terminal 1, and the DRM mode information extracting section 102 decodes it using the secret key of the client terminal 1.

Then the decryption section 15 supplies the video multimedia data to the video decoding section 16, and the audio multimedia data to the audio decoding section 19.

Receiving the encoded video multimedia data from the decryption section 15, the video decoding section 16 of the client terminal 1 decodes the multimedia data under the control of the control command transmitting/receiving section 13.

When the video decoding section 16 decodes the multimedia data, the video display section 17 of the client terminal 1 displays the video on the monitor 18 in accordance with the multimedia data.

When the electronic watermark information is impressed in the multimedia data decoded by the video decoding section 16, the electronic watermark extracting section 22 extracts the electronic watermark information from the multimedia data.

Receiving the encoded audio multimedia data from the decryption section 15, the audio decoding section 19 of the client terminal 1 decodes the multimedia data.

When the audio decoding section 19 decodes the multimedia data, the audio output section 20 of the client terminal 1 reproduces the multimedia data and outputs the audio via the speaker 21.

As is clear from the foregoing description, the present embodiment 8 is configured in such a manner that when the DRM mode indicated by the client terminal 1 differs from the DRM modes available to the license server 2 and distribution server 4, the license server 2 requests the DRM mode converting server 6 to convert the DRM mode in the multimedia contents; and the DRM mode converting server 6, when it receives the conversion request of the DRM mode from the license server 2, converts the DRM mode of the multimedia contents distributed from the distribution server 4 to the DRM mode available to the client terminal 1, and transfers the converted multimedia contents to the client terminal 1. Thus, the present embodiment 8 offers an advantage of being able to distribute the multimedia contents to the client terminal 1 even when the plurality of DRM modes installed in advance do not include the DRM mode available to the client terminal 1.

Although the present embodiment 8 is described by way of example that converts the encryption scheme and the license description scheme, it is also possible to convert the electronic watermark scheme in the same manner as in the foregoing embodiment 1.

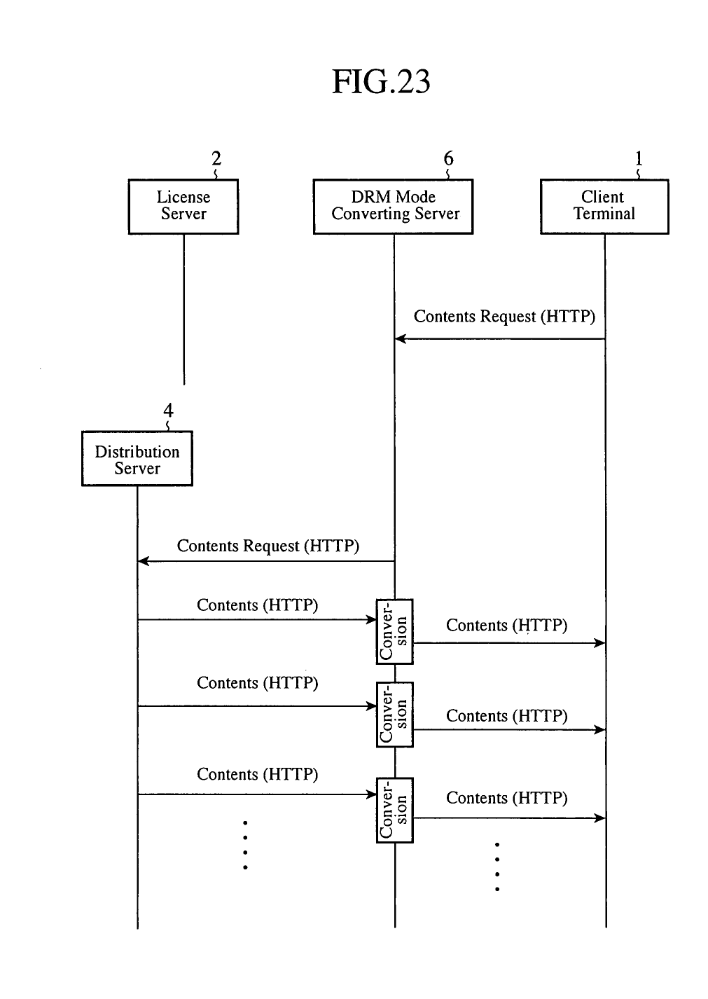

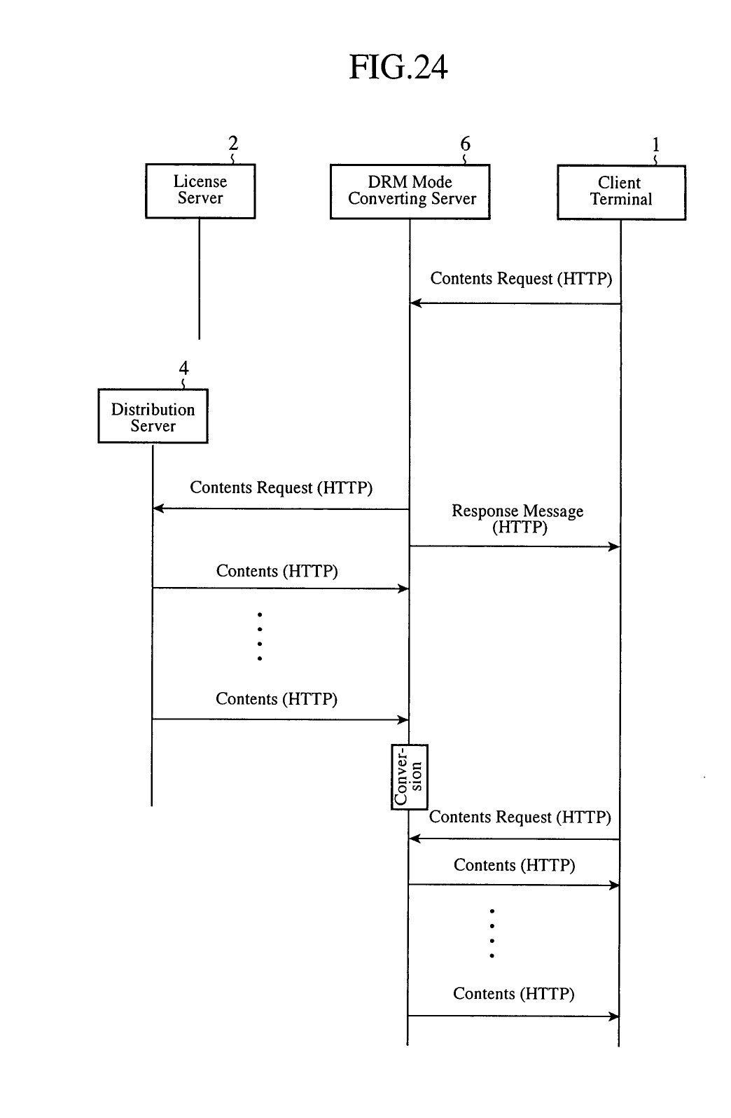

FIG. 23 and FIG. 24 are each a sequence chart illustrating the processing of the contents distribution system of the embodiment 8 in accordance with the present invention.

More specifically, FIG. 23 illustrates a sequence when the contents distribution system carries out the distribution with receiving the contents and converting the DRM mode information; and FIG. 24 illustrates a sequence when the contents distribution system carries out the distribution after receiving all the contents and converting the DRM mode.

Although the present embodiment 8 is described by way of example as illustrated in FIG. 23 in which the DRM mode converting server 6, receiving the multimedia contents, sequentially decodes the encryption of the contents, and carries out the processing of converting the DRM mode information for encrypting the contents again, such conversion is not always necessary.

More specifically, consider the case where the DRM mode converting server 6 stores all the contents received from the distribution server 4 once, and then carries out the conversion as illustrated in FIG. 24. In this case, receiving the download request of the contents in HTTP from the client terminal 1, the DRM mode converting server 6 sends back to the client terminal 1 a message in HTML that the client terminal 1 should access the designated URL after a set period of time in order to convert the contents form.

Then, after downloading all the contents, the DRM mode converting server 6 converts the encryption scheme and stores the license information, followed by distributing the contents to the client terminal 1.

In this way, even when the DRM mode such as the available encryption scheme and the description form of the license information differs between the client terminal 1 and distribution server 4, it is possible to implement the distribution of the multimedia contents with carrying out the DRM mode by downloading via the DRM mode converting server 6. It is effective when the client terminal 1 has only limited CPU capacity as in a mobile terminal and hence the available DRM mode is restricted.

In addition, the present embodiment 8 can impose the charge of using the DRM mode converting server 6 in the same manner as in the foregoing embodiment 1 by managing the number of contents distributed via the DRM mode converting server 6 for each user.

### Embodiment 9

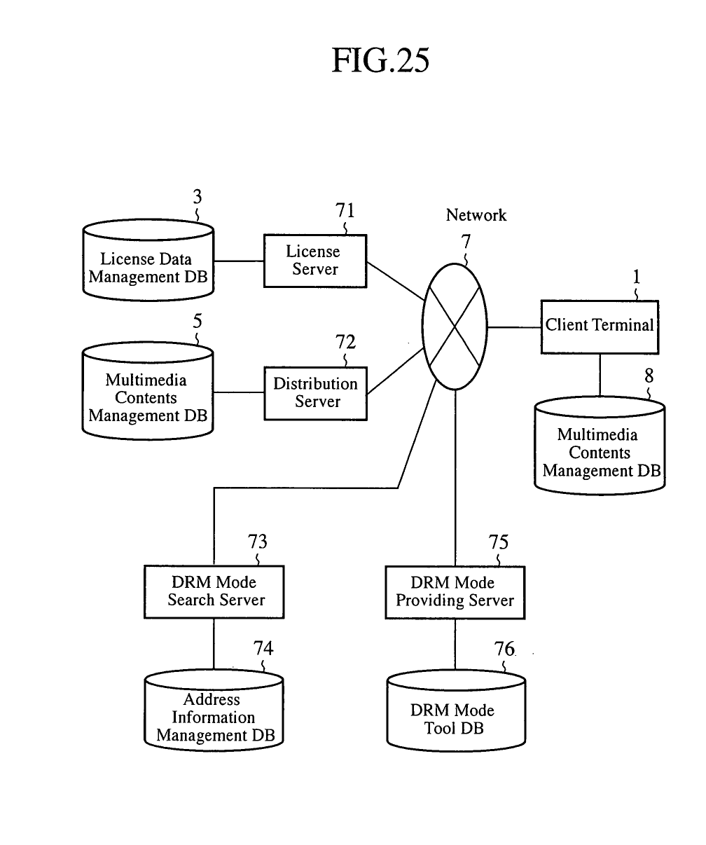

FIG. 25 is a block diagram showing a configuration of the contents distribution system of an embodiment 9 in accordance with the present invention. In FIG. 25, since the same reference numerals as those of FIG. 13 and FIG. 19 designate the same or like portions, their description will be omitted.

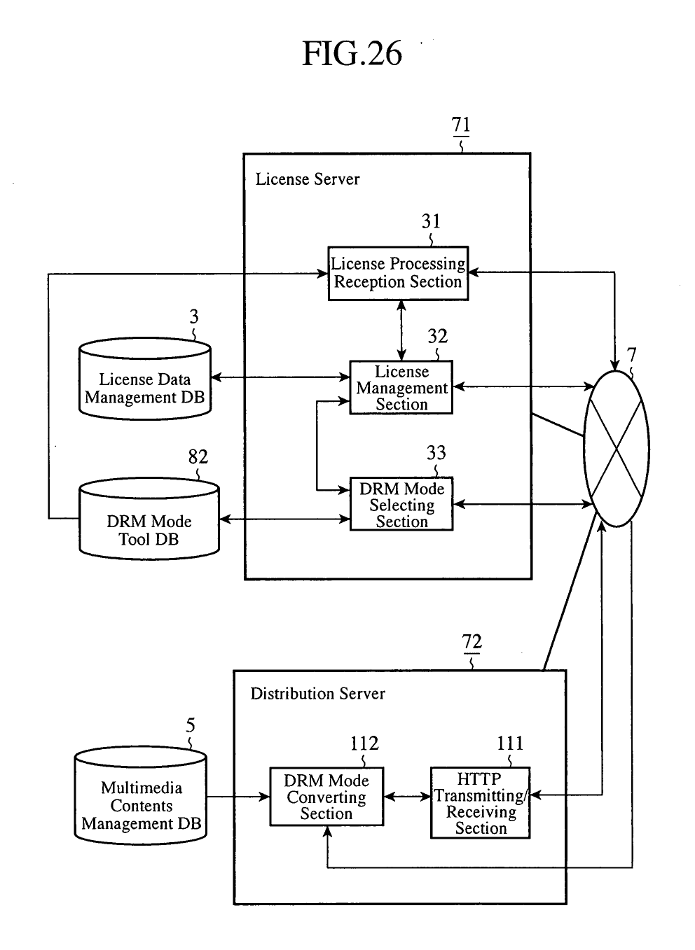

FIG. 26 is a block diagram showing a configuration of the license server 71 and distribution server 72 of the contents distribution system of the embodiment 9 in accordance with the present invention. In FIG. 26, since the same reference numerals as those of FIG. 14 and FIG. 21 designate the same or like portions, their description will be omitted.

A DRM mode converting section 112 of the distribution server 72 carries out the processing of converting the DRM mode of the multimedia contents.

Although the foregoing embodiment 8 is described by way of example in which the DRM mode converting server 6 converts the DRM mode of the multimedia contents and distributes the multimedia contents, this is not essential. For example, when the client terminal 1 notifies the license server 71 of the DRM modes available to the client terminal 1, and when the DRM modes available to the license server 71 and distribution server 72 differ from the DRM modes available to the client terminal 1, the license server 71 can obtain the DRM mode tool available to the client terminal 1 from the network, and distribute the multimedia contents using the DRM mode.

Next, the operation will be described.

As for the user authentication between the client terminal 1 and license server 71 and the list display processing of the available contents, they are the same as those of the foregoing embodiment 8.

In addition, as for the processing for the user to select the browsing desired multimedia contents, and for the client terminal 1 to notify the license server 71 of the list data of the DRM modes available to the client terminal 1, it is the same as that of the foregoing embodiment 5.

Furthermore, as for the decision processing of the DRM mode to be employed among the license server 71, distribution server 72, client terminal 1, DRM mode search server 73 and DRM mode providing server 75, and as for the acquisition processing of the DRM mode tool of the license server 71, they are the same as those of the foregoing embodiment 5.

In the present embodiment 9 also, the license server 71 corresponds to the Ver.2 DRM mode adopted by OMA (Open Mobile Alliance). In addition, it is assumed that the client terminal 1 employs a scheme in which when the client side transmits a client certificate to the server side, the server side encrypts the encryption key of the contents with the public key of the client terminal 1, and transmits it, which is carried out rather easily.

As in the foregoing embodiment 5, the client terminal 1 receives the license information which is generated using the DRM mode tool the license server 71 downloads, and is transmitted.

Receiving the license information transmitted from the DRM mode converting server 6, the DRM mode notification section 12 of the client terminal 1 sends the license information and the contents URL to the HTTP transmitting/receiving/display section 11.

The HTTP transmitting/receiving/display section 11 stores the license information in the license management DB 101.

The HTTP transmitting/receiving/display section 11 transmits the download request of the contents to the distribution server 72.

Receiving the download request of the contents transmitted from the client terminal 1, the HTTP transmitting/receiving section 111 of the distribution server 72 supplies the download request to the DRM mode converting section 112.

Receiving the download request from the HTTP transmitting/receiving section 111, the DRM mode converting section 112 of the distribution server 72 searches the multimedia contents management DB 5 for the multimedia contents corresponding to the contents ID, and reads the multimedia contents.

Reading the multimedia contents, the DRM mode converting section 112 accesses the license management section 32 of the license server 71 to acquire the decoding key of the multimedia contents, and decrypts the encryption of the multimedia contents using the decoding key. For the communication of the decoding key, a secure communication scheme such as SSL or the like is used.

Then, the DRM mode converting section 112 encrypts the plaintext multimedia contents in the encryption scheme utilized by the DRM mode available to the client terminal 1 using the encryption key stored in the license information, and supplies the encrypted multimedia contents to the HTTP transmitting/receiving section 111.

Receiving the encrypted multimedia contents from the DRM mode converting section 112, the HTTP transmitting/receiving section 111 of the distribution server 72 transmits the encrypted multimedia contents to the client terminal 1 in HTTP.

Receiving the multimedia contents transmitted from the distribution server 72, the client terminal 1 stores the multimedia contents in the multimedia contents management DB 8 as in the foregoing embodiment 8.

After that, the file reading section 103 of the client terminal 1 checks the license information in cooperation with the DRM mode information extracting section 102 as in the foregoing embodiment 8. Then the decryption section 15 acquires the decryption key from the DRM mode information extracting section 102, and decrypts the encryption of the multimedia contents.

Subsequently, the video decoding section 16 decodes the video multimedia contents, and the video display section 17 displays the video on the monitor 18. On the other hand, the audio decoding section 19 decodes the audio multimedia contents, and the audio output section 20 reproduces the audio to be output from the speaker 21.

Although the present embodiment 9 is described by way of example that converts the encryption scheme and the description scheme of the license, it can also convert the digital watermark scheme.

### INDUSTRIAL APPLICABILITY

As described above, the contents distribution system in accordance with the present invention is suitable for a system in which the license server for managing the license information, the distribution server for distributing the multimedia contents, and the client terminal for receiving and restoring the multimedia contents are connected through the network, and in which the distribution server distributes to the client terminal the multimedia contents the client terminal requests.

What is claimed is:

1. A contents distribution system comprising:
a client terminal for making a notification of available DRM modes, and for restoring multimedia contents when the multimedia contents are distributed;
a contents distribution apparatus for transmitting, when a DRM mode indicated by said client terminal differs from the DRM modes available to the contents distribution apparatus, a conversion request of the DRM mode in the multimedia contents; and
a DRM mode converting apparatus for converting, when receiving the conversion request of the DRM mode from said contents distribution apparatus, the DRM mode of the multimedia contents distributed from said contents distribution apparatus to the DRM mode available to the client terminal, and for transferring the multimedia contents passing through the conversion to said client terminal.

2. The contents distribution system according to claim 1, wherein said contents distribution apparatus, when capable of using the DRM mode indicated by the client terminal, directly transmits the multimedia contents to said client terminal.

3. The contents distribution system according to claim 1, wherein said contents distribution apparatus manages a number of times of requesting said DRM mode converting apparatus to convert the DRM mode.

4. The contents distribution system according to claim 1, wherein said DRM mode converting apparatus converts a distribution mode of the multimedia contents distributed from said contents distribution apparatus from a multicast mode to a unicast mode.

5. The contents distribution system according to claim 1, wherein said DRM mode converting apparatus halts transfer of the multimedia contents to said client terminal when none of the available DRM modes have safety strength corresponding to importance of the multimedia contents distributed from said contents distribution apparatus.

6. A contents distribution system comprising:
a client terminal for making a notification of available DRM modes, and for restoring multimedia contents when the multimedia contents are distributed;
a contents distribution apparatus for requesting, when a DRM mode indicated by said client terminal differs from the DRM modes available to the contents distribution apparatus, to download a DRM mode tool for implementing the DRM mode indicated by said client terminal, and for distributing, when receiving the DRM mode tool, the multimedia contents to said client terminal by carrying out the DRM mode tool; and
a DRM mode providing apparatus for transmitting, when receiving the download request of the DRM mode tool from said contents distribution apparatus, the DRM mode tool to said contents distribution apparatus.

7. The contents distribution system according to claim 6, wherein said contents distribution apparatus manages the number of times of requesting download from said DRM mode providing apparatus.

8. The contents distribution system according to claim 6, wherein said DRM mode providing apparatus halts transmission of the DRM mode tool to said contents distribution apparatus when none of the DRM modes available to the client terminal have safety strength corresponding to the importance of the multimedia contents.
